(19) United States
(12) Patent Application Publication
(10) Pub. No.: US 2014/0089032 A1
(43) Pub. Date: Mar. 27, 2014

(54) MANAGEMENT SYSTEM AND METHOD

(71) Applicant: GENERAL ELECTRIC COMPANY, Schenectady, NY (US)

(72) Inventor: David BELL, Jacksonville, FL (US)

(73) Assignee: GENERAL ELECTRIC COMPANY, Schenectady, NY (US)

(21) Appl. No.: 14/027,332

(22) Filed: Sep. 16, 2013

Related U.S. Application Data
(60) Provisional application No. 61/703,795, filed on Sep. 21, 2012.

(51) Int. Cl. G06Q 10/06

(52) U.S. Cl. CPC G06Q 10/06314
USPC 705/7.24

(57) ABSTRACT

Systems and methods for providing a graphical interface and application for managing assets and products in and between shipper/receiver facilities. A shipper/receiver management application manages assets and products and provides selectable options to a user to control operations across the shipper/receiver facility and between shipper/receiver facilities. Aspects include inventory and/or workflow management to facilitate timing and control facets of inventory, production planning, and graphical representations thereof for both shippers and receivers.

This patent application claims priority to pending provisional U.S. patent application Ser. No. 61/703,795 filed on Sep. 21, 2012 which is incorporated herein by reference in its entirety.

### BACKGROUND

1. Technical Field

The subject matter disclosed herein relates to methods and systems for managing assets, products, storage, and transportation within and between shipping and receiving facilities of a shipper or a receiver.

2. Discussion of Art

A shipping or receiving facility may have products (e.g., raw materials) and assets (e.g., storage containers, rail cars, on-site transportation vehicles) located throughout which are to be managed in various ways (e.g., moved, loaded, unloaded, stacked, linked, assigned). Keeping track of the products and assets and the status of the products and assets in a shipping or receiving facility (and during transportation between shipping and receiving facilities) can be challenging. It may be desirable to have a system that helps a user manage products and assets within and between shipping and receiving (S/R) facilities better than those systems and methods that are currently available.

### BRIEF DESCRIPTION

In at least one embodiment, a method (e.g., for inventory control and workload management) is provided. The method can include various aspects using a controller, such as receiving one or more product locations of one or more products within a facility, receiving one or more asset locations of one or more assets within the facility, receiving an order for at least one of the one or more products, assigning at least a portion of the at least one of the one or more products to at least one of the one or more assets to complete the order, and scheduling a fulfillment of the order based one or more workflow times associated with one or more tasks.

In at least one alternative or complementary embodiment, a system comprising a controller can be provided. The controller can be configured to receive a product inventory relating to one or more products at a facility, receive an asset inventory relating to one or more assets at the facility, receive a set of orders including one or more product orders and one or more statuses associated respectively with the one or more product orders (wherein the statuses include location information describing at least one location associated with the one or more products and the one or more assets), control generation of a representation of at least a map of the facility including the location information to be displayed on a user device, and produce a notification based on the location information that prompts one or more tasks related to the set of orders.

In at least one additional alternative or complementary embodiment, a system can be provided that includes at least an enterprise resource planning system, a controller, and a user device. In particular, the enterprise resource planning system can be configured to schedule an order to be fulfilled from an inventory at a facility. The controller can be associated with the facility and communicatively linked to the enterprise resource planning system, and can be configured to allocate the inventory to a plurality of assets at the facility based at least in part on the order. The user device can be communicatively linked to the controller, and can be configured to receive from the facility management controller a workflow list based on the order.

### BRIEF DESCRIPTION OF THE DRAWINGS

Reference is made to the accompanying drawings in which particular embodiments of the invention are illustrated as described in more detail in the description below, in which:

FIG. 1 is a schematic block diagram of an exemplary embodiment of a system to visually and graphically manage products, assets, and activities within and between shipper and receiver facilities;

FIGS. 2A and 2B illustrate exemplary embodiments of display screens of a map view, of a shipper/receiver facility (“S/R facility”) generated by the system of FIG. 1;

FIG. 3 illustrates a second exemplary embodiment of a display screen of a map view, of a transportation route generated by the system of FIG. 1;

FIG. 4 illustrates an exemplary embodiment of a display screen of a plant view of a shipper/receiver facility generated by the system of FIG. 1;

FIGS. 5A and 5B illustrate exemplary embodiments of display screens of a list view of a shipper/receiver facility generated by the system of FIG. 1;

FIGS. 6A and 6B illustrate exemplary embodiments of display screens showing how to sort and filter using the list view of FIGS. 5A and 5B;

FIGS. 7A and 7B illustrate exemplary embodiments of display screens showing the color coding of assets and products in the map view of FIGS. 2A and 2B;

FIG. 8 illustrates an exemplary embodiment of a portion of the string of the display screen of FIG. 4, showing the color coding of the assets and products of the portion;

FIGS. 9A and 9B illustrate exemplary embodiments of display screens showing the color coding of assets and products in the list view of FIGS. 5A and 5B;

FIGS. 10A and 10B illustrate exemplary embodiments of display screens showing a “parking lot” function;

FIG. 11 illustrates an exemplary embodiment of a display screen generated by the system of FIG. 1 showing information associated with providing interchange support of inbound assets (e.g., rail cars) into the S/R facility;

FIG. 12 illustrates an exemplary embodiment of a display screen generated by the system of FIG. 1 showing information associated with loading an asset (e.g., a railcar) within the S/R facility;

FIG. 13 illustrates an exemplary embodiment of a display screen generated by the system of FIG. 1 showing information associated with a product master list;

FIG. 14 illustrates an exemplary embodiment of a display screen generated by the system of FIG. 1 showing information associated with an equipment group master list;

FIG. 15 illustrates an exemplary embodiment of a display screen generated by the system of FIG. 1 showing information associated with an equipment kind master list;

FIG. 16 illustrates an exemplary embodiment of a display screen generated by the system of FIG. 1 showing information associated with a location (e.g., storage area) master list;

FIG. 17 illustrates an exemplary embodiment of a display screen generated by the system of FIG. 1 for the setup of infrastructure (e.g., a plant/track/spot) within the S/R facility;

FIG. 18 illustrates an exemplary embodiment of a display screen generated by the system of FIG. 1 for security and user setup;

FIG. 19 illustrates an exemplary embodiment of a display screen generated by the system of FIG. 1 for a color scheme setup; and

FIG. 20 illustrates a flowchart of an embodiment of a method for fulfilling an order using the inventory and workload management (IWM) functionality described herein using the system of FIG. 1.

### DETAILED DESCRIPTION

Systems and methods for providing a graphical interface and application for representing and managing products and assets within and between S/R facilities such as plants, yards, ports, warehouses, or lots of a shipper or a receiver are disclosed. Embodiments of the invention provide the S/R facility management software application configured to manage products and assets within and between S/R facilities pro-actively by maximizing visibility of the S/R facilities and by providing selectable options to a user to improve operations across the S/R facility and between S/R facilities. In embodiments, aspects can be directed toward management of inventories and/or workloads at one or more facilities.

The subject matter disclosed herein relates to methods and systems for managing assets, products, storage, and transportation within and between shipping and receiving facilities of a shipper or a receiver. Embodiments of the invention relate to methods and systems providing displayed representations and a graphical interface for managing products and assets within and between shipping and receiving facilities such as plants, yards, ports, and warehouses.

Some shippers may be concerned with a production process and where to place a product after it has been produced. For example, produced material may be in the form of bulk product (e.g., chemicals) and may be placed in a storage container. Some shippers use rail cars as storage containers in addition to other transportation vehicles. Therefore, when material is produced, a shipper may ensure that rail cars are present to accept the product. A shipper may desire to keep track of product inventory in the shipper facility to support dispatching product out to customers and may further desire to track the product all the way to its destination point during shipping to a customer (e.g., a receiver).

Receivers are concerned with inventory and knowing how much product is on hand and how many days of production can be supported. Receivers are also concerned with inbound deliveries of materials and product including how much product is on its way, how far away the product is, and how many days out the product is. A shipper or receiver works closely with, for example, a rail carrier such that product ends up where it is supposed to be on time. In accordance with an embodiment, communication between a shipper or receiver and a rail carrier takes place via electronic data interchange (EDI) communications.

As used herein, a “product” may refer to materials provided by an entity to a consumer. Products may be produced (e.g., manufactured from other inputs) or distributed without modification. Thus, with respect to a single entity, a product may be what the entity sells or exchanges for value in return. A product may be any material or good that may be transported. A material may include an input used in a product, or other matter incident to production or operation of a facility. Products and/or materials may be combined, blended, mixed, and so forth, in various schemes (e.g., loaded on the same asset but boxed differently, loaded on the same asset but easily segregated as with chunks of ore and large logs, loaded on same asset and mixed, as with different ores that may be combined in an alloy, and so forth). A product may be a material or vice-versa to different entities within a supply chain or within the same entity. An “inventory” may be a quantity of product, material, or other matter. An inventory refers to an amount in a facility, but may also include amounts throughout an entity or enterprise, or amounts that may be otherwise available for the purposes of the inventory (e.g., for production, for sale to consumers, and others). There may be inventories of other items (e.g., assets).

Products, inventories, and other aspects may exist (e.g., as a discrete item, in particular quantities) at locations (e.g., within a plant, on tracks between buildings, in a truck between a shipper and a receiver). Locations may be absolute (e.g., latitude/longitude value), relative (e.g., located at a known position in a plant), and/or combinations thereof. Products, inventories, and other aspects may be repositioned, resulting in their location being changed. Repositioning may be effected, for example, to stage products for use or shipment, to prioritize or order a plurality of inventories, to create space for other products or the performance of tasks, and other reasons.

The term “shipper” refers to an entity in the business of shipping products via some form of transportation (e.g., via trucks in an on-highway fleet or rail cars on a railroad). A shipper may be in the business of producing, mining, or processing the product (e.g., coal) to be shipped. The term “receiver” refers to an entity in the business of receiving products from shippers via some form of transportation (e.g., via tractor trailers). A receiver may or may not also be in the business of using or further processing the product (e.g., plastic pellets).

The terms “container” and “trailer” refer to a storage medium or area configured to hold products, goods, or other shippable or receivable materials. These aspects may be examples of “assets.” The term “shipper or receiver (S/R) facility” refers to a facility, location, site, or area where products and assets may be managed. The term “S/R facility” may be used to refer to a facility of a shipper, a receiver, or both. The managing of products and assets may include, for example, moving, loading, unloading, storing, stacking, linking, assigning, shipping, and receiving the products and assets. The term “asset” refers to anything that may be managed in the S/R facility or between S/R facilities. Examples of assets include, but are not limited to, rail cars; ships; other shipping transportation vehicles; storage containers or storage areas for storing products or assets; containers/trailers that may be loaded/unloaded with product and loaded/unloaded from rail cars, ships, or other shipping transportation vehicles; or transportation vehicles for moving, loading, and unloading products within the S/R facility. When in use in support of or assigned to an order, maintenance, et cetera, at least a portion of an asset may be non-available (e.g., cannot be assigned for that time period to another order).

Assets may be operated by one or more entities, meaning a particular entity owns, possesses, uses, conveys, maintains, performs, or is responsible for various other aspects related to one or more assets. A “private asset” as used herein may be an asset owned or operated by a third party other than the shipper. A “private fleet” may be a fleet of assets owned or operated by the third party.

As with products and inventories, assets may have locations, and may be repositioned between locations. Assets may be “released” to other entities, which may refer to the administrative process(es) used to provide possession of an asset to an entity that may perform a function involving the asset (e.g., conveyance, maintenance, loading). Alternatively, releasing may can refer to permission or conditions set to advance through a workflow or an order fulfillment (e.g., released from shipper to depart for receiver).

As used herein, an “asset class” may be one or more assets associated with one or more characteristics. For example, rail cars may be an asset class among all assets, and tanker railcars may be an asset class (or sub-class) among railcars. In embodiments, an asset class refers to all assets sharing one or more characteristics. In embodiments, an asset class refers to a particular model of identical assets. In embodiments, a single asset may belong to two or more classes or sub-classes.

Assets may relate to target and/or maximum daily asset loadings. A target daily asset loading may relate to optimal, minimum, or “non-exigent” (e.g., barring unusual circumstances) maximum loadings for assets. Loading may be measured in numbers of assets or products, and there may be target loadings for particular classes of assets, or assets may be weighted or treated differently in a composite target loading. A maximum daily loading may be a number which should not be exceeded with respect to assets related to a facility, enterprise, or a subset thereof.

Assets may have modifying terms associated with them. For example, for an asset may be owned by a shipper, the shipper may abide various governmental or third party regulations that may be supplemented with internal policies, support or warranty guidance, and other aspects. Alternatively, assets can be owned by a third party who may lease, rent, finance, lend, et cetera, one or more assets to a shipper. Various contract terms related to uses, maintenance and tax liabilities, other associated entities (e.g., repair shops), routes used, and so forth may govern the use of assets. An asset's actual use may be what may be actually done with the asset, and may be in fulfillment or violation of the asset terms.

As used herein, an “entity” may be any individual, group, or business involved in the transfer of materials. In embodiments, entities may belong to or control other entities (e.g., as in parents and/or subsidiaries). If two or more entities may be discussed, the two entities represent distinct parties not sharing all resources such that some exchange occurs when resources transfer from one entity to the other. While this refers to some combination of products, materials, and money flowing between the two entities according to valuation of portions of the combination in terms of other portions of the combination, it may be appreciated that various other incentives (e.g., development of goodwill, sampling, and others) and/or deferment of a portion of a deal (e.g., consignment, exchange, advance credit, and others) may be involved in the exchange. As used herein, a “consumer” may be an entity that consumes or utilizes a product from an upstream entity. Other examples of entities herein may include (but may not be limited to) shippers, receivers, producers, private fleets and/or private fleet managers, repair shops and/or other business entities related to some aspect of transactions, and others.

As alluded to above, a “transfer” may include any movement of product, material, asset, and/or other matter. While transfers may be described in terms of external exchanges between entities, it may be to be appreciated that transfers may occur within a single entity (e.g., material transferred from one asset to another, from one location to another, from one business to another, and so forth). Transfers between a single entity may occur, for example, to facilitate production, efficient utilization of assets or space, staging for an outgoing shipment, to accommodate an incoming shipment, and other reasons. Multiple transfers and re-transfers may be cognized under the singular “transfer,” such as when a material may be conveyed through multiple points or nodes within one or more entities before being utilized in whole or part.

As used herein, an “order” may include a request for one or more products and/or materials. An order may be fulfilled or completed through (or may otherwise be related to) one or more exchanges or transactions between two or more entities. In embodiments, an order may be completed through (or may otherwise be related to) one or more exchanges or transactions within a single entity (e.g., between business units, between facilities, for accounting purposes, and so forth). One or more order statuses may be associated with an order. Order statuses may include information relevant or of interest to any entity with interest or involvement in the order, such as exchange amounts (e.g., product/material quantities, money for product/material, other fees), shipment timing, delivery timing, payment timing, assets associated with the order, and others. Order statuses may be updated based on processing or fulfillment. For example, order statuses may be updated to indicate an order has been received, an order has been forwarded for fulfillment, at least a portion of the order may be being fulfilled (e.g., being picked or loaded), at least a portion of the order may be shipped, at least a portion of the order may be fulfilled, and so forth. Order status updates may refer to a specific portion or parties related to the portion (e.g., a particular line involved with a particular product) or the order at large. These examples may be to be construed as providing non-exhaustive details related to the spirit of order statuses (and orders), and other details or status information may be provided herein.

Orders may be scheduled, such that they may be planned for fulfillment and at least one instruction or resource may be in place to the accomplishment of such ends. Sets of orders may be scheduled to manage a plurality of orders and de-conflict (e.g., ensure no aspects related to the order such as product quantities or assets may be being used in support of another order, may be assigned to be used in support of another order during a period of time, or may be otherwise unavailable) the resources or prioritize instructions. New orders may be received and added to the sets or schedules, resulting in various adjustments to the new order, other orders, sets, or schedules.

The term “workflow” may be a progression of aspects to accomplish an end. For example, a workflow to deliver one or more products may include production, preparation, and shipment. Each aspect may in turn be its own workflow. For example, production may include determining a production quantity, preparing the raw materials, scheduling labor and equipment, and creating the product. Put another way, a workflow may include one or more tasks, and tasks may include sub-tasks or aggregate to a larger task. Workflows may facilitate the flow of material (and/or information) or task accomplishment in a way that minimizes delay or inefficient use of resources. Workflows may have times associated, such as a previous, average, or predicted time to complete a workflow or portion thereof. Tasks may have times associated, and may be added to determine a workflow time based on the tasks. Workflows may have associated workflow lists that provide a listing of necessary tasks or aspects, and may also (but need not) provide details concerning their relationships, scheduling, and management. “Workload” may indicate aggregate workflow aspects, tasks, or other requirements on an entity or subsets thereof.

Orders (and workflows or tasks that relate to one or more orders) may have costs associated. For example, the time, labor, assets, bandwidth, fuel, and other costs associated with a shipper may be directly attributed to orders or averaged across orders. Thus, both direct and indirect costs may be associated with an order. In embodiments, different means of fulfilling an order (e.g., different time frames, different routes, different loading combinations, different assets, and so forth) may result in different costs associated with the order. Order schedules (including, e.g., assets to be used, routes, timing, and so forth) may be planned or modified in view of costs, including changes to costs based on new or fulfilled orders. Particularly, an order-asset cost may be one or more costs associated with fulfilling an order based on the asset used.

Revenues may also be considered in aspects herein. Revenues may be amounts generated or received based on the sale of goods (e.g., a product itself) or services (e.g., shipment of the product), or through other means. An order-asset revenue may be an amount of revenue generated based on an order fulfilled at least in part by an asset. Order-asset revenue may change based on the asset selected.

Related to aspects described may be one or more shipping solutions, which may include details for fulfilling an order. The shipping solution may not be complete until relevant products/materials, assets, resources, workflows, et cetera, may be reserved and de-conflicted with other shipping solutions.

Similarly, a shipping plan may be a plan or aspects to fulfill one or more orders based on costs and assets. In embodiments, a shipping plan may include scheduling one or more orders.

As used herein, production may be the creation of a product or other process adding value for a downstream or other consumer, but need not be limited to such exclusive definition. For example, in some services, “production” may be invoked to refer to the portion of a unit that works for or supports entities outside the unit, and may drive the unit's value by providing quid pro quo to various entities. A production schedule may be the timing related to the occurrence of production, as well as requirements incident to production (e.g., asset availability, labor, maintenance, and others). Various schedules related to production or other aspects. may be described. In embodiments, a production schedule, or other schedule, may be based on a customer schedule. A customer schedule may be based on customer expectations and/or requirements. For example, a customer schedule may be a time at which the customer may expect to receive a product, a time at which the customer may be prepared to receive a product, a time the product may be in accordance with the customer's production or shipment schedule, and others. Order schedules may be schedules including a time of order receipt, projected or actual ship time, projected or actual receipt time, and so forth.

As used herein, an “equipment availability matrix” may be at least a text- or graphics-based informational display that may indicate times of equipment (including assets) availability or non-availability. For example, when an asset may be assigned to an order and scheduled to ship, the asset may be non-available at least until the order may be projected to be complete, and may be non-available until the asset may return from its trip, be serviced or re-fitted, et cetera. Equipment availability matrices may be based on actual times (current or historical), average times, predicted times, others, and combinations thereof.

As used herein, a “map” may be a visual representation of space in a two-dimensional rendering.

As used herein, visual characteristics may include the aesthetic and/or functional aspects of appearance in an interface or other aspects. While color-coding may be discussed herein, other aspects such as icons, including the shape, size, opacity, et cetera thereof may indicate particular information. Various icons/images, text, and other symbols may be included in one or more aspects including visual characteristics. Visual characteristics may blend disparate sources to composite images (e.g., cartoon-like icons superimposed over satellite or ground-based photos of facilities or portions thereof) or be uniform in appearance (e.g., wholly computer-generated imagery). Further, other sensory information (e.g., sounds, tactile information) may be utilized in combination with or as a substitution for various visual characteristics.

“Software” or “computer program” as used herein includes computer readable and/or executable instructions, stored in a non-transitory computer-readable medium, that cause a controller or other electronic device to perform designated functions, designated actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like.

“Computer” or “processing element” or “computer device” as used herein includes, but may be not limited to, any programmed or programmable electronic device that may store, retrieve, and process data. “Non-transitory computer-readable media” include, but may be not limited to, a CD-ROM, a removable flash memory card, a hard disk drive, a magnetic tape, and a floppy disk. “Computer memory”, as used herein, refers to a storage device configured to store digital data or information which may be retrieved by a computer or processing element. “Controller”, as used herein, refers to the circuits/circuitry, logic circuits/circuitry, and/or processing elements, possibly including associated software or program(s) stored in a non-transitory computer-readable medium, that is configured for the managing of assets and products associated with a facility as set forth herein. The terms “signal”, “data”, and “information” may be used interchangeably herein and may refer to digital or analog forms. The term “communication device” as used herein may refer to any wired or wireless device (e.g., a computer modem) operable to receive and/or transmit signals, data, or information. The term “virtual” as used herein refers to the simulation of real world objects and characteristics in a computer environment. As used herein, a “module” may be a computer-related component (e.g., software, hardware, combinations thereof, and so forth) providing at least the described functionality. For example, a module may be a software application, a portion of a software application, an electronic device, and/or others.

Some of the systems and methods described herein may be discussed in the context of shippers and receivers using rail cars and railroad transportation. However, embodiments of the invention may apply equally well to other types of shippers and receivers using other types of transportation such as, for example, port entities using sea-going vessels, mining equipment, on-road trucks, and the like.

In one embodiment, a system may monitor vehicle and container dwell times. Monitoring dwell time may allow control that influences productivity, may reduce or eliminate demurrage charges, may capture vehicle or container inspection information, may report vehicle or container status, may capture a characteristic parameter relating to a product or group of products or an asset or group of assets, and may pre-block vehicles and containers for efficient hand off to an operator or carrier. Vehicles and containers may be pre-blocked according to a destination or other parameter. For example, a railway train may have a pre-defined number of blocks, and a shipper may communicate with a rail carrier to assemble a block of cars to fill a block in the train.

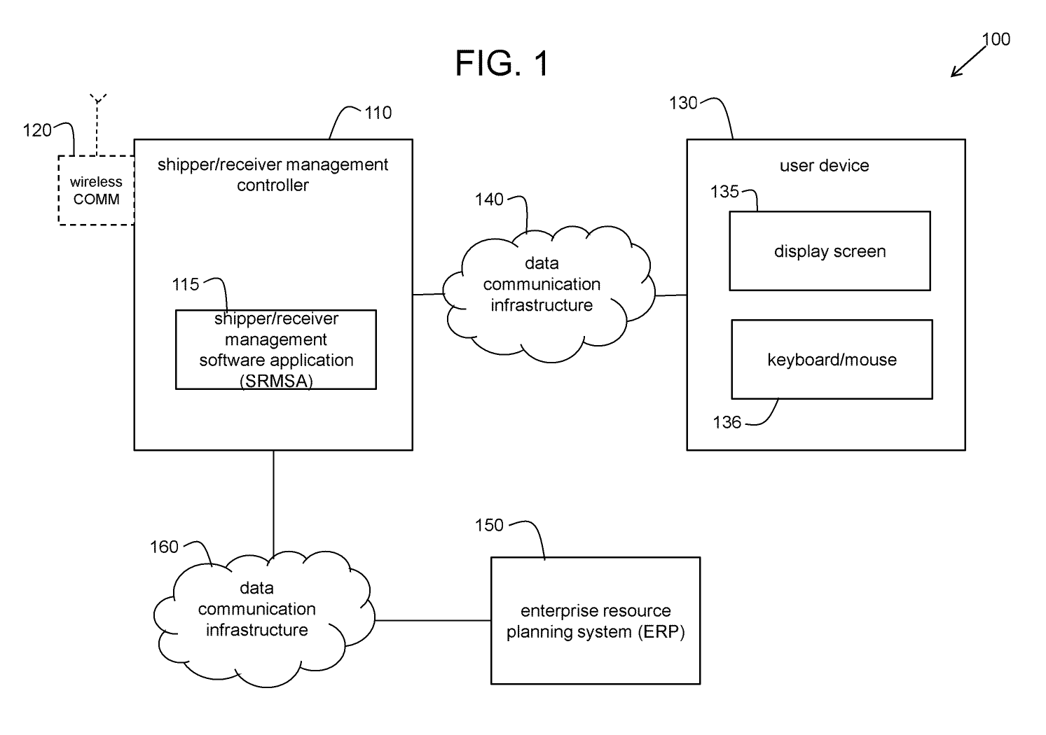

In embodiments herein, systems and methods may provide inventory and workload management (IWM) functionality. The IWM functionality may be implemented as a separate IWM application (e.g., standalone application or a component of another application) or as an IWM module which may be part of a shipper/receiver management software application (SRMSA) application, in accordance with various embodiments (e.g., see FIG. 1).

The inventory and workload management functionality may provide shippers and receivers with the ability to manage incoming and/or outgoing product and/or material quantities and various assets. The IWM functionality may enable production planning, determination of order status and fulfillment rates, as well as the ability to manage asset inventory through a single integrated graphical mapped-based platform. A shipper may be producing product and a receiver may be consuming product (e.g., bulk product such as coal or gravel) and the respective entities may desire to manage the amount of product that has to be produced and shipped, or the amount of product that may be on hand (i.e., in inventory).

Production planning may be facilitated at various levels according to or in conjunction with IWM techniques described herein. In embodiments, one or more IWM modules may interface with, leverage functionality from, and/or supplement functionality to one or more integrated or disparate (e.g., from separate entities) enterprise resource planning systems.

One or more IWM modules may track material and/or product inventory. Inventories may be stored in (or controlled at least in part by) assets. In embodiments, such assets may include International Standards Organization (ISO) containers, railcars, bins, silos, piles, tanks, and other storage devices within a plant or yard, or portions of the plant or yard utilized by such (e.g., storage pad with a pile of material thereon). In various embodiments, assets may be identified (e.g., individually, in groups, and so forth). Each asset or group of assets may have a known capacity for a particular material or product (e.g., dimensions of pile that will fit on storage pad) or for any material or product (e.g., weight limit for centerbeam railcar, maximum volume for coal railcar).

In accordance with one or more embodiments of the invention, the utilized or available capacity of one or more assets may be monitored. For example, a gondola railcar may be one-third full of a material, or two-thirds empty. Various other aspects may be associated with knowledge of an asset's capacity. For example, loading and unloading time, transport cost at a particular capacity, items compatible or easily separated that may exist within the same asset, expected movement (e.g., customer, destination, route, timing) and so forth. In this way, assets may be efficiently allocated to maximize utilization (e.g., of capacity), as well as combine orders or materials in a way that best facilitates inventory and workload management. In another example, a ship may be loaded to 10% of capacity, requiring 8 hours to unload. However, a new urgent order may be received, and it may be more profitable to offer current customers receiving at least a portion of the ship's expected loading a discount for delay rather than delay the urgent order. One or more IWM modules may determine solutions, with and/or without unloading the current cargo, designed to best utilize the ship (as well as other available assets) to satisfy all customers and maximize profitability for entities involved.

In addition to asset capacities and capacity utilization, other information regarding materials and/or products stored in each asset may be maintained on a per-asset and group bases. For example, the product(s) and/or material(s) stored and respective amounts (as distinguished from total capacity amounts), loading and/or balancing information, location (e.g., in a facility and/or in transit between facilities), special information (e.g., hazardous materials), the value of the asset with or without products/materials aboard, maintenance or repair information, and other information may be maintained. In embodiments, information about testing certifications associated with one or more stored products may be related to the assets or product information related to respective assets. Embedded functionality may allow for product blending or mixing and monitors product test results (e.g., on a per batch basis) for products requiring certification to facilitate IWM aspects and efficient solutions in support thereof.

Color-coding, or other types of coding, may be employed to graphically inform a user of the status of product and assets. In embodiments, more than one color code or code may be utilized with each asset in accordance with IWM techniques disclosed herein.

In embodiments, transfer(s) of material/product from storage devices and/or production to assets may be managed in support of IWM. This may be performed independent of or in conjunction with tracking of assets.

In embodiments, one or more IWM modules may allow a user to view how much product has been applied to an order (e.g., loaded and shipped in a particular rail car), and how much product may fulfill an order (including a remainder/partial order).

Determinations regarding when to ship a product for an order, based at least on when a product may be due at a receiver, may be provided. In addition, various production planning aspects may be used to determine when to ship a product for an order, or when to move or modify inventories of materials and/or products.

Once loaded, a rail car may be issued and released (e.g., to a serving entity taking control of the asset, from a staging area, and others). For example, a railcar may be released to a serving railroad. In embodiments, this function may be automatic (e.g., requiring no operator interaction) using one or more IWM modules based on one or more conditions. In alternative or complementary embodiments, the IWM modules may enable an operator to release an asset. When dispatched, the asset may be tracked en route to a destination. Various dispatch information (e.g., predicted ship date, actual ship date, expected transit time, and others) may be viewed for each asset en route.

One or more embodiments of IWM modules herein may utilize one or more IWM alerts. IWM alerts may be received on the occurrence of particular events related to workload management and requisite inventories. For example, when an asset departs a destination, arrives at its destination, may be delayed en route to a destination, and so forth, various alerts indicating fulfillment or changes may be provided. IWM alerts may be used independently or in conjunction with notifications to one or more ERP systems associated with entities involved in the transaction.

For receivers, embodiments of one or more IWM modules may facilitate tracking of inventory. In embodiments, an IWM module may facilitate real time, en route, continually-updated monitoring of one or more shipments. In embodiments, an IWM module may estimate a time of arrival and plan or suggest timing for production, asset management, facility maintenance/downtime (e.g., time when production or shipment may be not occurring at least with respect to one line, asset, et cetera), and other aspects based at least in part on the estimated time of arrival. When an asset arrives at a receiver destination, the transfer of product to storage devices, and/or other vessels (e.g., water-borne or others, in ports or various environments), may be managed and/or monitored.

In accordance with an embodiment, one or more IWM modules may plan and monitor workflows involved throughout the process of receiving, inspecting, cleaning, repairing, moving, loading/unloading rail cars as well as the product transfer process. Such tracking and managing may be accomplished from an office environment (e.g., via a desk top computer) or from an integrated application module running on a mobile device (e.g., a smart phone or tablet device).

In a non-limiting example of some aspects related to at least one embodiment of an IWM module, a first company may provide material to a second company, which the second company may use to produce products sold to consumers. Both the first company and second company maintain independent ERP systems, and at least one of the first company and the second company use production planning aspects in conjunction with one or more IWM modules herein.

To provide timely servicing of consumer orders, the second company may ensure its production corresponds flexibly with consumer demand. For example, if they cannot keep pace with consumer demand, their inventories may dwindle and they may be unable to meet their outstanding orders. If they outpace consumer demand, they may have an amount of capital pending in inventory, and may run out of assets or space in which to manage inventory. There may be other costs associated with inefficient production management. Efficient production management may balance inflows and outflows of materials and products. If too much material for future production may be on-hand, assets, space and capital may be excessively tied in material and potentially create bottlenecks to the efficient storage and movement of completed product. If too little material may be on-hand, resource planning and continuous production flexibility may become constrained while the second company awaits a next delivery from the first company.

The first company's work flow may be intertwined with the second's. If the first company does not maintain carefully forecast, but still flexible, inventory and workflow, they may lose the second company or other customers for impacting their business. However, as with the second company, assets, space and other resources may be finite, and the first company may also be dependent on other upstream entities, and may be committed to other downstream entities. Thus, the first company may resolve efficient solutions for managing its workflow and material/product inventories.

Thus, IWM modules as described herein (alone or in combination with one or more ERP systems) may facilitate solutions within a single entity or between a plurality of entities to ensure sound planning related to the movement of materials and/or products and/or the assets associated therewith. Production planning or other functions of one or more IWM modules may be based on, for example, amounts of products and/or materials on-hand, amounts of products and/or materials expected to be received, amounts of products and/or materials expected to be shipped, assets available at a given time (e.g., currently available, expected to become available, available until a certain time, entering or leaving service with one or more entities, and others) to manage products and/or materials, pending orders, completed orders, expected orders, production rates, other facilities or units of the same entity, other facilities or units of different entities, movement forecasting (including but not limited to changes to movement in view of damaged assets, weather, disruptions such as track damage, and others), and/or other aspects.

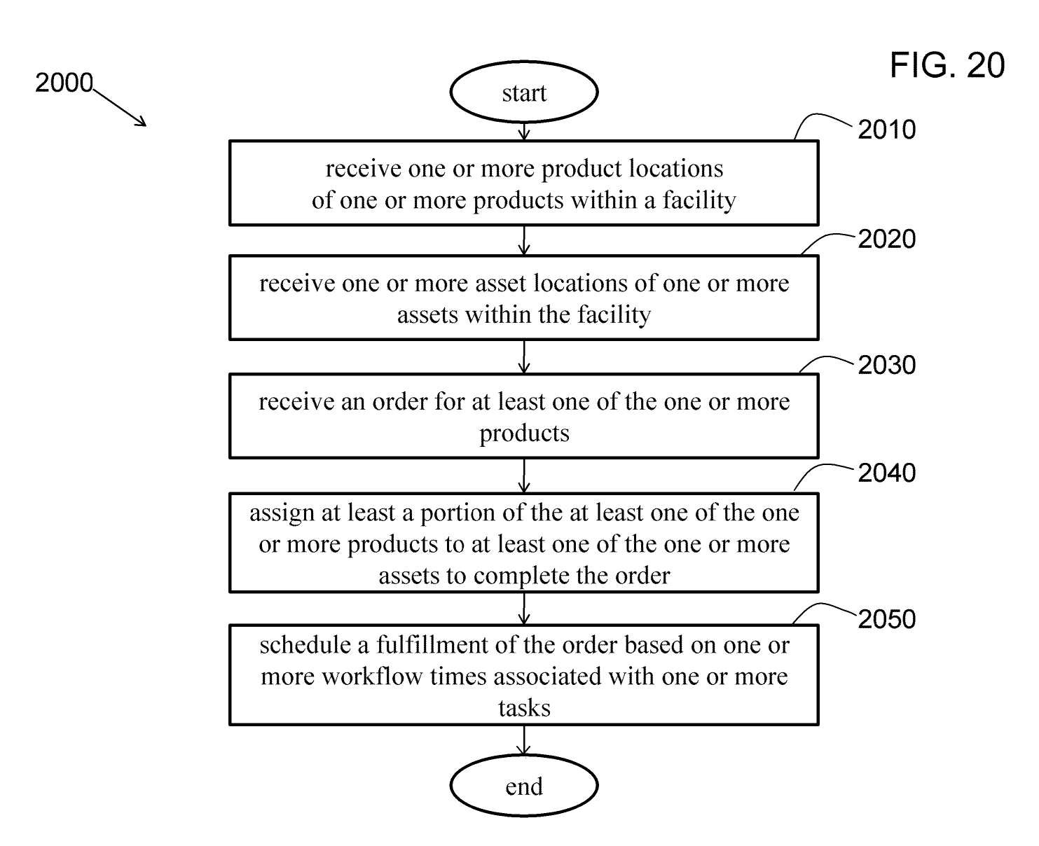

FIG. 20 illustrates a flowchart of an embodiment of a method 2000 for fulfilling an order using the inventory and workload management (IWM) functionality described herein using the system 100 of FIG. 1. Details of the system 100 are described in below herein. In step 2010 of the method 2000, one or more product locations of one or more products within a facility are received (e.g., received at a controller having IWM functionality, from an enterprise resource planning system, which can be accessed by a user device). In step 2020, one or more asset locations of one or more assets within the facility are received. In step 2030, an order for at least one of the one or more products is received. In step 2040, at least a portion of the at least one of the one or more products is assigned to at least one of the one or more assets to complete the order. In step 2050, a fulfillment of the order is scheduled based on one or more workflow times associated with one or more tasks.

Turning now to FIG. 1, a schematic block diagram of an exemplary embodiment of a system 100 is shown. The system may be used to visually and graphically manage products, assets, and activities within and between S/R facilities. The S/R facility may be, for example a plant, a yard, a port, a warehouse, or a lot or any location and/or facility where products and assets may be managed (e.g., moving, loading, unloading, storing, stacking, linking, assigning, shipping, and receiving the assets and products). Assets associated with the S/R facility may be loaded or unloaded with product at the S/R facility. Embodiments of the invention provide functionality associated with the loading/unloading process and provide integration to the enterprise resource planning system (ERP) of a shipper or receiver.

The system may include a shipper/receiver management controller 110 operable to manage products, assets, transactions, and activities taking place within the S/R facility. The controller 110 is operable to control a displayed representation of the S/R facility and products and assets located in the S/R facility, along with characteristics of the products and assets. Selectable options may facilitate managing the products and assets within the S/R facility through a graphical interface. Functionality allowing interfacing with an entity that delivers assets (e.g., rail cars) to the S/R facility may be provided. For example, the system may respond to a vehicle or container being ready for dispatch by initiating an electronic data interchange (EDI) request. The request may instruct a carrier to come and get the vehicle or container from a shipper's facility. Similarly, if the carrier holds a container for a shipper the EDI request may be made instructing the carrier to deliver the container to the shipper's facility. Integrated inbound and outbound asset and product visibility may be provided, along with automation of key tasks and production of work orders for train crews.

In one embodiment, the S/R management controller 110 may be implemented as a computer server running a shipper/receiver management software application (SRMSA) 115. The S/R management controller may manage products and assets within the S/R facility (e.g., the assignment, loading, unloading, and movement of products and assets within the S/R facility), and may provide a graphical mapping that allows visualization of the S/R facility by a user on a display screen. The S/R management controller may provide a graphical mapping that supports visualization of transportation assets, having product loaded thereon, in transit (en route) between S/R facilities along with estimated times of arrival.

As an option, the system may include a wireless communication (COMM) device 120 operably interfacing to the controller and able to communicate with other wireless devices (e.g., via radio frequency communication) operating within the S/R facility. Such other wireless devices may be hand-held devices used by inspectors, or may be located in on-site transportation vehicles within the S/R facility.

The system may include a user device 130 (e.g., a desktop personal computer, a hand-held tablet computer, or a mobile telephone) having a user interface including a display screen 135 (e.g., a touchscreen display) and, optionally, a keyboard and/or a mouse 136. The user device may communicate with the S/R management controller either directly or via a data communication infrastructure 140 (e.g., a computer network). The user device may be located in an office on site at the S/R facility, or may be remotely located away from the S/R facility. In accordance with an embodiment, the user device may be a mobile, wireless, touch-screen, hand-held device that may be used by a user as the user walks or drives around the S/R facility (e.g., if the user is part of a maintenance crew). The system may provide a directional locator function, directing a user to a product or asset within the S/R zone that may be selected by the user.

The system may include an enterprise resource planning system (ERP) 150 in operative communication with the S/R management controller 110 via, for example, a data communication infrastructure 160 (e.g., the internet). The ERP 150 may be configured to manage various aspects (e.g., scheduling, tracking, way billing, revenue accounting) of a larger enterprise such as, for example, an entire shipping company having multiple S/R facilities. Therefore, the ERP 150 may communicate with a plurality of S/R management controllers at a plurality of S/R facilities of a shipper or receiver.

If the S/R management controller is on site at the S/R facility, the user device may communicate in a direct wired manner with the controller, or via a data communication infrastructure that may be a local area network. If the S/R management controller is remotely located from the S/R facility, then communication with the user device may be via a larger network, such as the internet. For example, the S/R management controller may be co-located with or be implemented on a same server computer as the ERP 150. As another example, the S/R management controller may be hosted at a third party site (e.g., a provider of the SRMSA) as a software-as-a-service (SaaS) configuration. As a further example, the data communication infrastructures may be the same network (e.g., the internet). Other configurations may be possible as well, in accordance with various other embodiments.

Shipping vehicles may be located throughout the S/R facility, may be loaded or unloaded, and may or may not be linked to a block of, e.g., rail cars to be moved by one or more locomotives of a railroad as a train. In one embodiment, the system provides a graphical interface on a display screen of the user device allowing a user to manage products and assets in the S/R facility. A user may interact with the S/R management controller via the user interface device to configure the layout of the S/R facility and tracks, paths, or other asset routes within the S/R facility, for example. The resultant configuration may reflect the current state of the S/R facility, or may reflect a desired state of the S/R facility to be implemented, or may represent both (e.g., using different visual style elements).

A user may then view the location of assets on asset routes (e.g., rail cars on tracks) within the S/R facility, check the status of a vehicle or container or other asset, update (move) the location of the vehicle or container or other asset within the S/R facility, and review or enter transportation (e.g., waybill/Bill of Lading) information for the vehicle, container, or other asset. A user may create if-then logic to help plan and manage asset movements within the S/R facility. Checking the status of the asset may involve, for example, checking if a car is loaded and with what product or commodity, checking the identity of the receiver of the loaded commodity, checking the assigned destination of the vehicle or container or other asset, and checking the owner (or lessor) of the vehicle or container or other asset. Waybill information for the asset may be checked and Bill of Lading information entered using the system of FIG. 1. In one embodiment, the user device may be used to verify tracking information physically associated with the asset, such as a radio-frequency identification (RFID) or automatic equipment identification (AEI) tag, or a barcode, or the like. That user device might scan the associated indicia and match it against the status information. The user may make updates or corrections to errors on the spot.

A method is provided in one embodiment that includes obtaining shipping or receiving information associated with products and assets located within the S/R facility. The obtained shipping or receiving information may be processed for the generation of displayed graphical representations of the products and assets located within the S/R facility. This may be done along with characteristics of the products and assets. Selectable options may be then provided to a user for reviewing and editing the shipping or receiving information.

The obtained shipping or receiving information may be processed for the generation of displayed graphical representations of the products and assets en route (in transit) between two or more S/R facilities. The processed shipping information may be passed to others, such as carriers, to facilitate transportation services. This information passing may be done, for example, via EDI communications. The graphical representations may be displayed as graphical icons and/or text information. The shipping or receiving information may be obtained from an enterprise resource planning system and may include Bill of Lading or waybill information. An analytic “dashboard” may provide status overviews on planning and productivity measures. Configurable role-based views may allow a user to make strategic decisions to manage upcoming work, optimize capacity, and reduce operating costs.

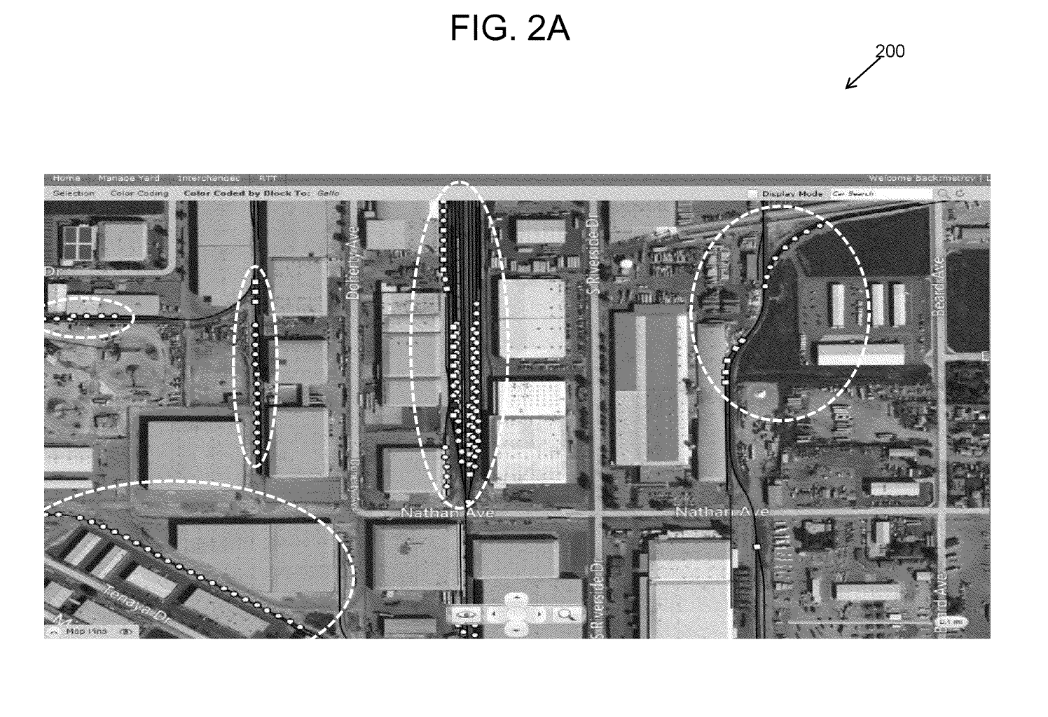

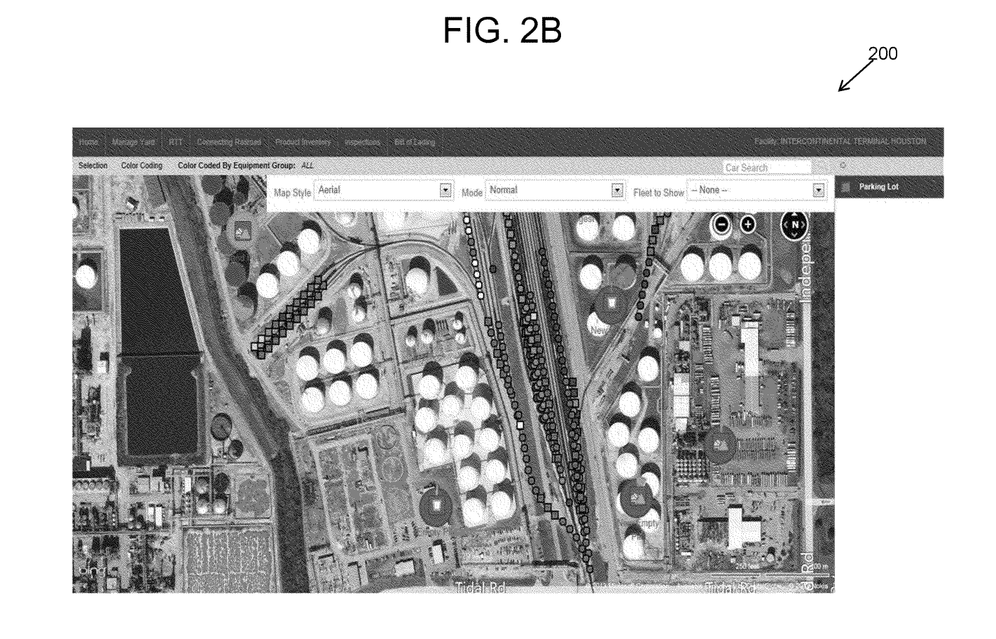

FIG. 2 illustrates a first exemplary embodiment of a displayed graphical representation 200 of the S/R facility provided by the system of FIG. 1, e.g., the user device 130 may be configured to display the graphical representation(s) 200 on the display screen 135. The graphical representation may comprise an aerial view (top down view) of the S/R facility. The aerial view may be a map (i.e., map view) of the S/R facility, or it may be an aerial photographic view (such as a satellite view as in FIG. 2) of the S/R facility, or it may combine elements of the two, e.g., a graphical representation of the S/R facility with tracks laid over a map of the area, such as in the scenario where the shipper or receiver ships or receives product by rail.

In embodiments, the system is also configured to display asset information (e.g., rail car information and storage area information) and/or product information (e.g., raw material information) as part of and/or in conjunction with the displayed graphical representations of the S/R facility. For example, the system may be configured to display the asset information and/or the product information as icons overlaid on the displayed aerial view of the S/R facility. The icons provide cues and/or information about the status and/or locations of assets and/or products, which may include an asset identification (ID) code, a loaded product type, product availability, product amount, a destination, an origin, a container type, asset health, equipment status, maintenance status, and/or load status.

The system may be configured to generate a displayed “refresh” icon. The refresh icon allows a user to update the displayed graphical representation to show the current inventory (products and assets) in the facility as overlaid icons (e.g., see the overlaid icons within the dashed ovals of FIG. 2). Also, the inventory (and associated information) may be automatically updated on determined schedule. The updated information may be received by the controller from the ERP 150, in accordance with an embodiment, and processed by the SRMSA 115 to refresh the view on the display screen 135 of the user device 130. The system may be configured for a user to also mark locations in the map view using marker points. A marker point is a point of interest on the map view that is selected by the user, which stays fixed until cleared by the user, and which may act as a reference point in the system for performance of one or more functions of the system. Such functions may include map zoom-in (i.e., generate an enlarged view of the aerial view) and zoom-out (i.e., generate a reduced view of the aerial view), e.g., zoom-in or zoom-out is carried out with reference to the marker point, and view indexing, e.g., if the user switches to another view and then returns to the view with the marker point, the view with the marker point is centered on the marker point, and/or the system may be configured to display a list of the extant maker points for switching between the views of the marker points based on user selection of the marker points in the list. The system may be configured to designate the marker points using displayed graphical representations, such as displayed graphical representations of pins (that is, an element displayed on the display that resembles a pushpin). In an embodiment, the system is configured so that when a marker point is designated by a user (e.g., a pin is placed), the system zooms in on the “pinned” location where the user desires to work. To add a new pin, a user may click on an “Add Pin” icon of the window and then click on the location to be pinned. An “Add Pin” pop-up window may appear and the user may enter a name for the pin and specify whether the pin should be visible to only the user (“my view”) or to all users (“shared view”). A pin may designate a default view such that, when a user goes to the map view, the view will open to that pin. In the map view, a user may switch between pin locations by either selecting a pin from a list in the window, or by clicking on the pin directly on the map (e.g., using a mouse).

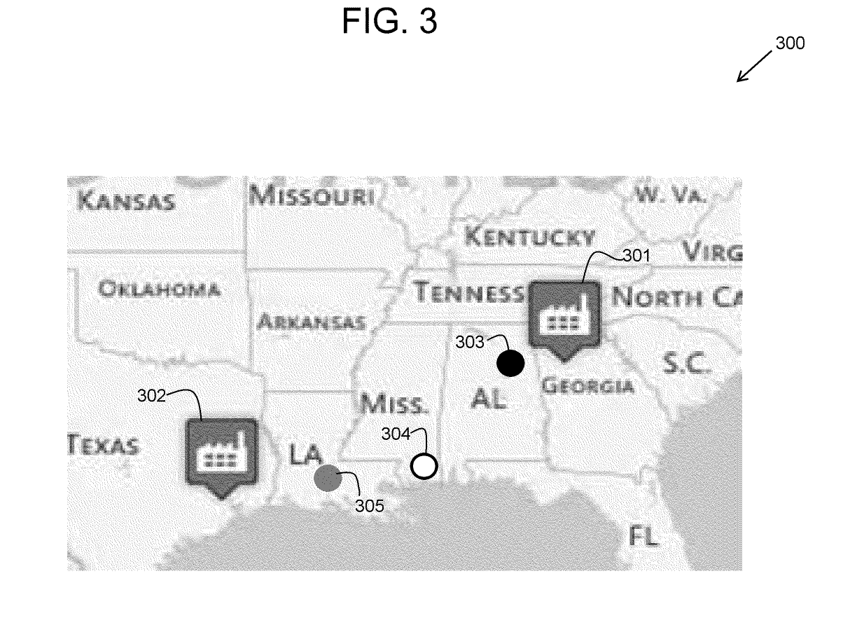

FIG. 3 illustrates an embodiment of a displayed map view 300 of a transportation route provided by the system of FIG. 1. The map view may be a graphic representation of a transportation route between two S/R facilities showing icons of assets carrying product in route between the two S/R facilities. A displayed icon 301 of a shipping facility may indicate on the map view as being located in a first location of the map (in the example of FIG. 3, Georgia). A displayed icon 302 of a receiving facility may be indicated on the map view as being located in a second location of the map (in the example of FIG. 3, Texas). A first group of vehicles and/or containers en route from the shipping facility to the receiving facility may be indicated by the icon 303, which may be located in a third location of the map (in this example, Alabama). A second group of vehicles and/or containers en route from the shipping facility to the receiving facility may be indicated by the icon 304 which may be located in a fourth location of the map (in this example, Mississippi). A third group of vehicles and/or containers en route from the shipping facility to the receiving facility may be indicated by the icon 305, which may be located in a fifth location of the map (in this example, Louisiana). Color coding of the icons, icon shape, and other icon characteristics may be used to indicate various asset characteristics including, for example, product type being transported by the assets and asset container type. A user may place a cursor over an asset icon (e.g., using a computer mouse, touchscreen manipulation, or other user input device) to view additional information (e.g., in text format) about the asset. The additional information may include, for example, weight information about the vehicles and/or containers or product loaded on the vehicles and/or containers, or other way billing information. In one embodiment, there may be an option to toggle to an enhanced mode that addresses disabilities in the user, such as blindness, color blindness, deafness, and the like. Enabling such an option may switch the icons and graphical representations into another mode of presentation—such as to audio, tactile, text, or another mode.

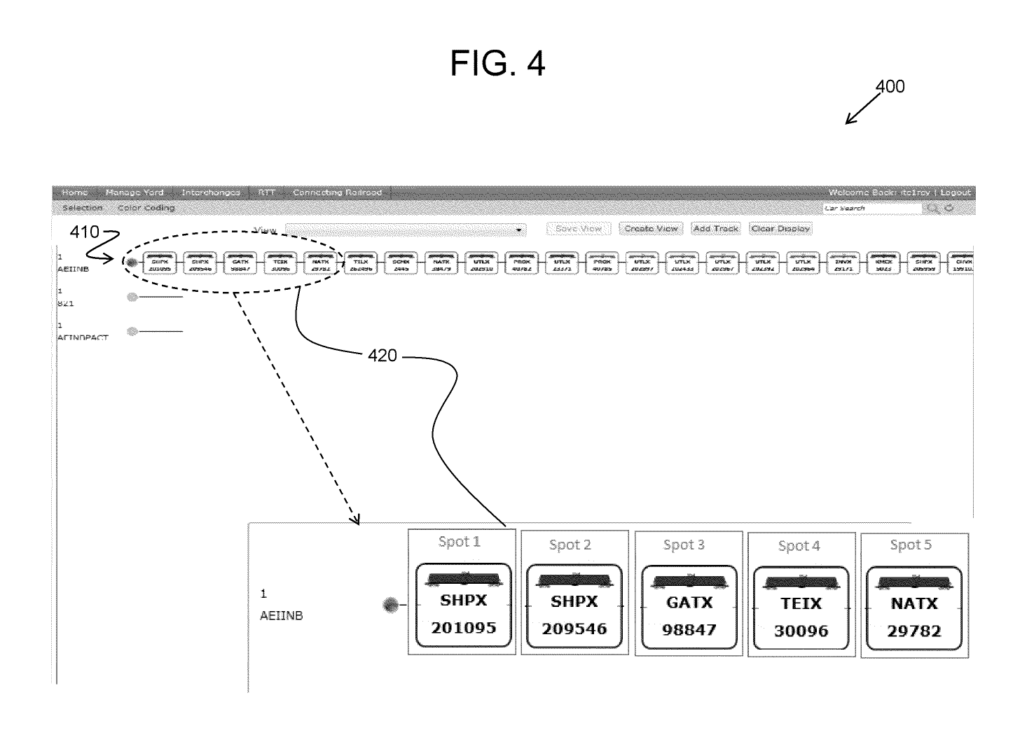

FIG. 4 illustrates an exemplary embodiment of a displayed plant view 400 of the S/R facility provided by the system of FIG. 1. The plant view may be a graphic representation of a string 410 of assets and products on a railway track (e.g., rail cars carrying storage containers on a track) in the S/R facility. The string shows the order of the assets (e.g., rail cars) as they appear on the track in relation to each other in various spots. However, the string does not indicate any particular geographic location(s). A portion 420 of the string 410 may be selectively enlarged for easier viewing in FIG. 4. Views may be created that contain graphical representations of the assets and products that the user works with or that the user works with most often, for example. This allows a user to more easily manage, for example, rail cars between railway tracks and storage areas. The plant view may be organized according to views that contain strings of assets and products specified by the user. A user may group strings together and switch between views by selecting from a “View” drop-down menu.

The system may be configured for a user to edit a view by adding or removing strings and clicking a “Save View” icon. For example, to create a new view, a user may click on a “Clear Display” icon to remove all strings from the window in the plant view. The user may then click the “Add Tracks” icon to select the strings that the user wants to view. The user may select from a list of storage areas that appear, and then click “Done”. All strings associated with the selected storage areas will appear in the view. An individual string or storage area may be removed by right-clicking on the string or storage area name and selecting “Remove from this View”. When a user is satisfied with a view, the user may click the “Create View” icon. A “New View” pop-up window will appear which may be named by the user. Again, the user may specify for the new view to be visible only to the user (My View) or to all users (Shared View).

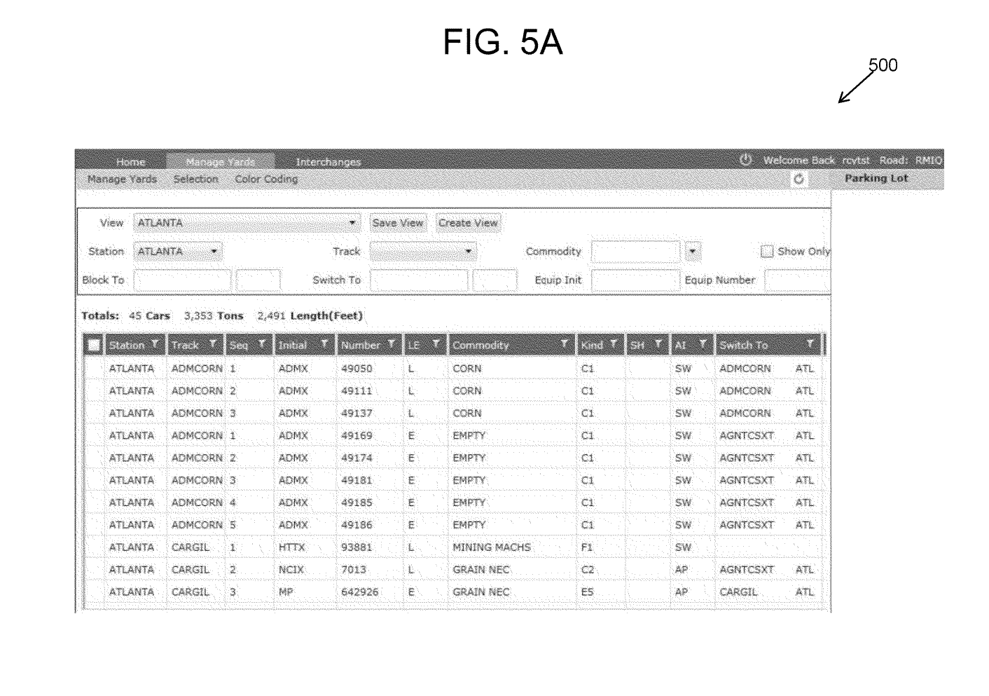

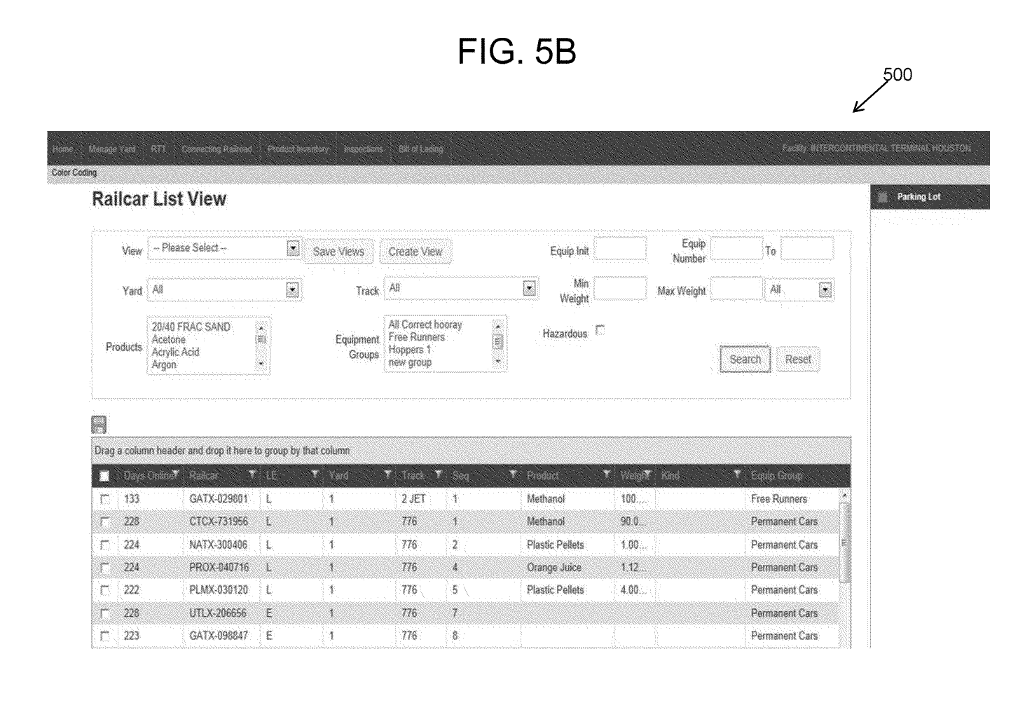

FIG. 5 illustrates an exemplary embodiment of a displayed list view 500 of the S/R facility provided by the system 100 of FIG. 1. The list view 500 may be a textual representation of assets and products in a plant. For example, shipping vehicles, tracks, and storage areas having product appear in a table format and views may be created that show the storage areas, shipping vehicles, and/or tracks that a user desires. The list view may be organized according to views that contain the assets and products specified by the user and allows a user to view the assets and products the user works with most often, for example. A user may switch between views by selecting from the “View” drop-down menu. A user may create a new list view by selecting “Clear Selection” from the “View” drop-down menu to remove, for example, all tracks and storage areas from the window, select the “Storage Area” and/or “Track” the user wants to view, and click on the “Create View” icon. A “New View” pop-up window will appear and, again, a user may specify a name and visibility of the new view. A user may click the “Update” icon causing, for example, all rail cars associated with a selected storage area and/or track to appear in the view.

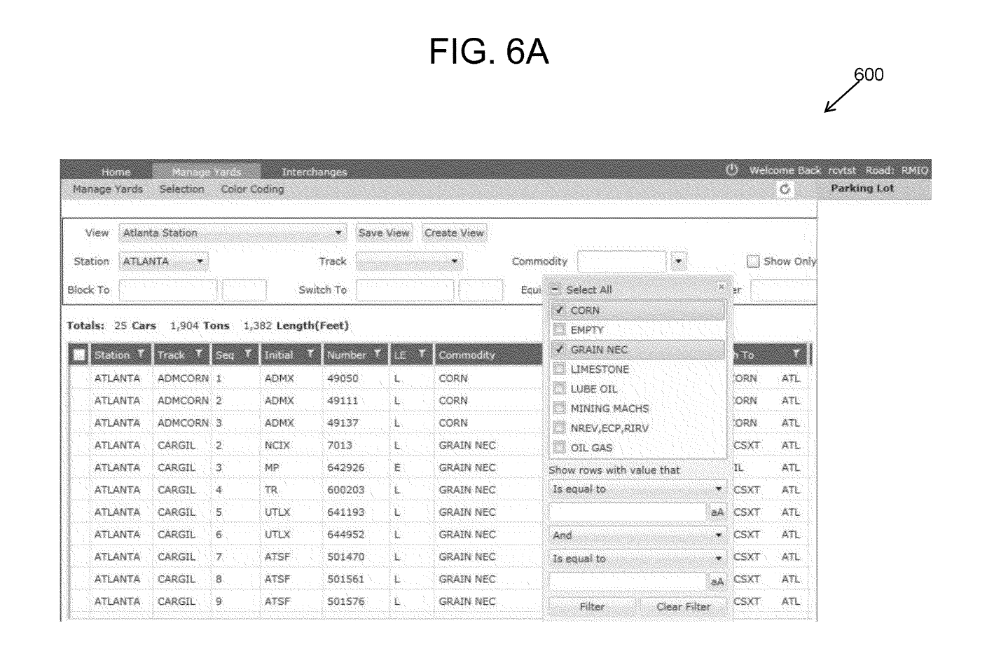

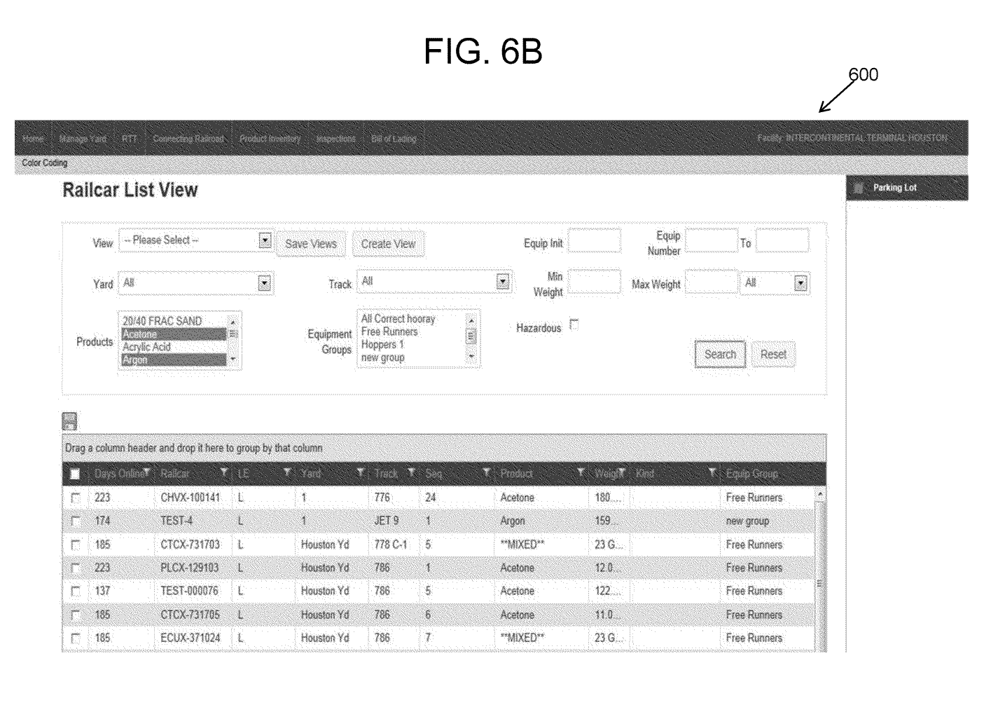

FIG. 6 illustrates an exemplary embodiment of data sorting functionality 600 of the system 100, for sorting and filtering the data of the list view of FIG. 5. In accordance with an embodiment, a user may sort the information of the assets and products in the list view by the values in any column. When a user clicks on a column header, the list may be sorted according to the information in that column. If a user clicks the column header again, the sort will change between ascending and descending order.

The system may also be configured for a user to also filter the information of the assets and products that appear in the list view using the values in any column. For example, if a user clicks on a filter icon (e.g., displayed with the appearance of a funnel-like element), a pop-up window appears and the user may select from the values appearing in the column or enter the values directly in the free-form fields. In addition to an “equal to” option, the free-form fields also provide a choice of filtering by values that do or do not begin with, end with, or contain a particular value. Once a user makes a selection, only assets and products that match the specified value(s) appear in the list.

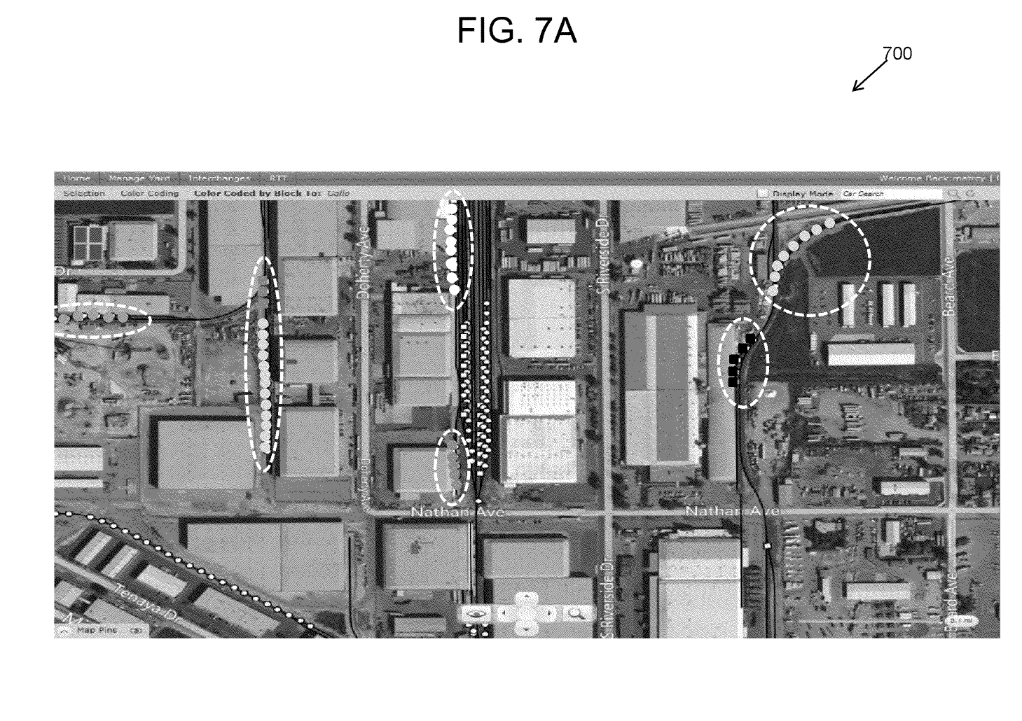

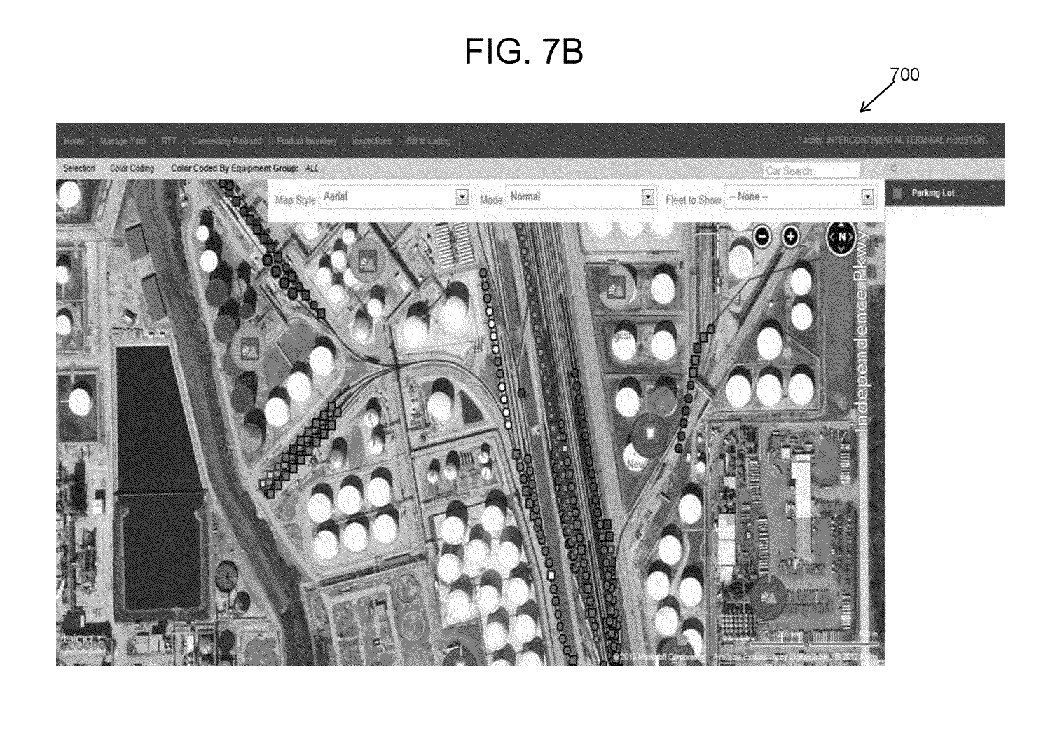

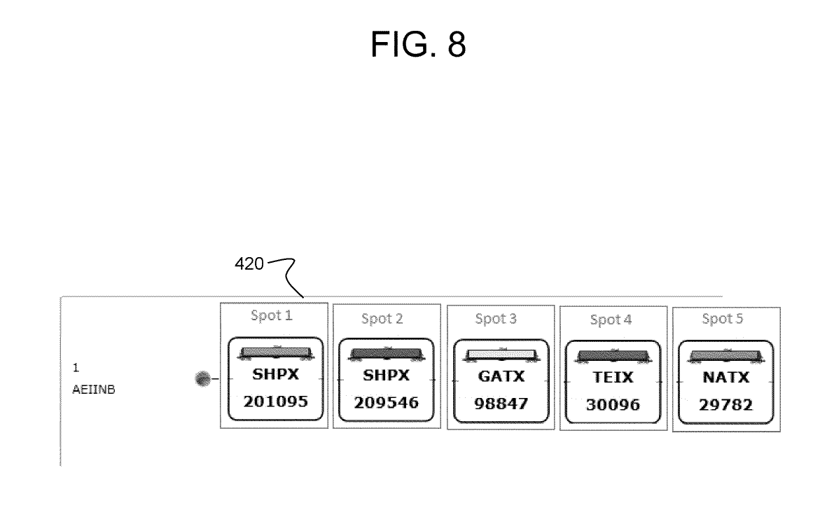

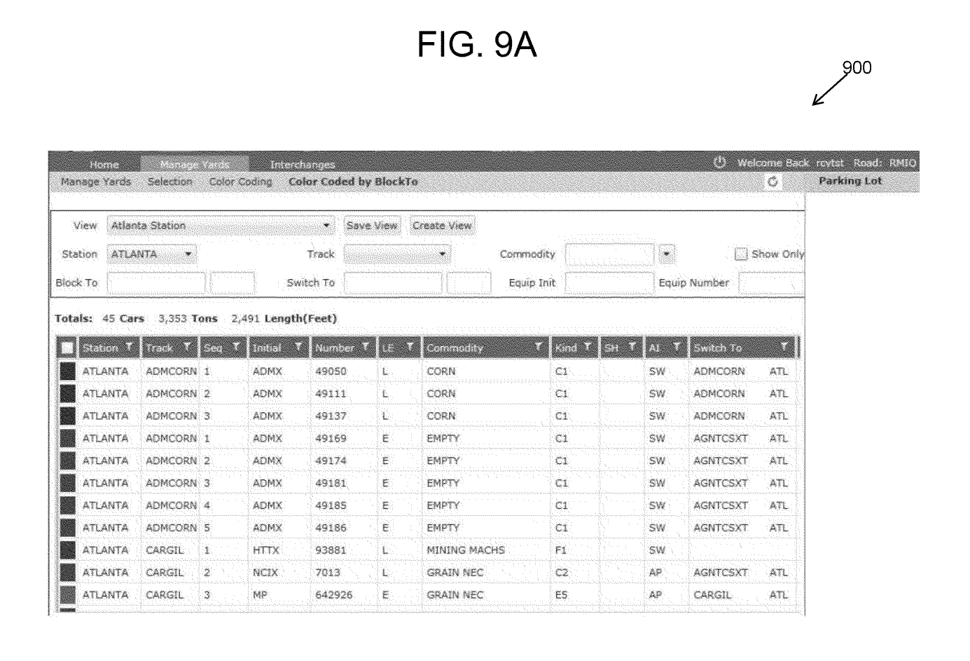

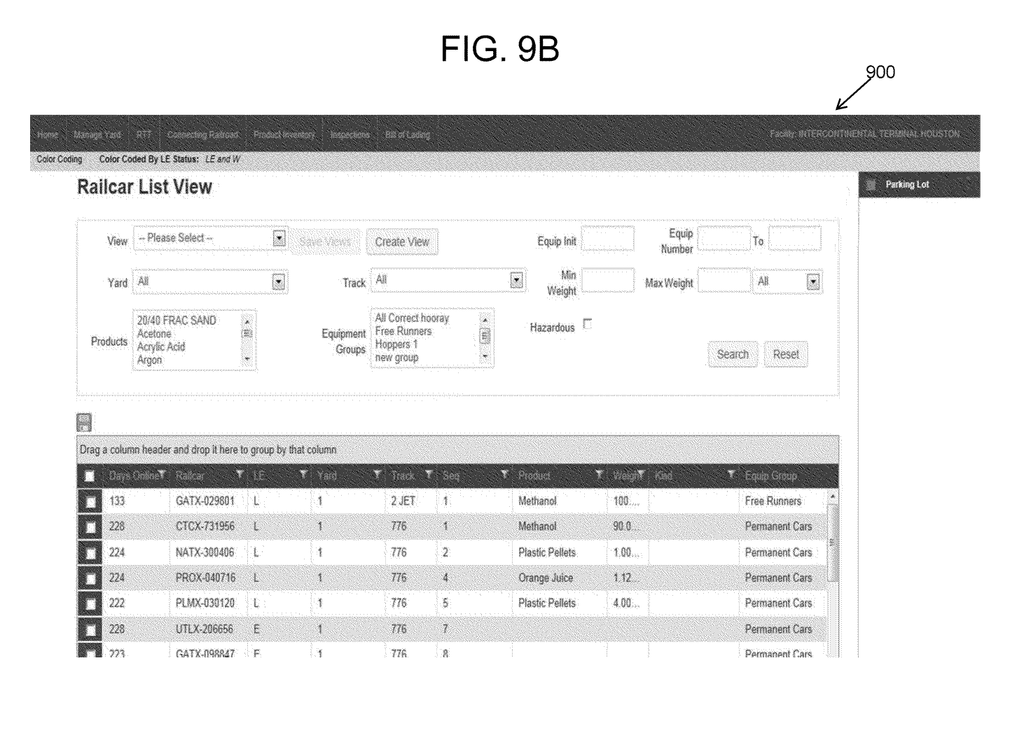

FIG. 7 illustrates an embodiment of a display screen 700 of the system 100 showing the color coding of graphical representations of assets and products in the map view 200 of FIG. 2. Using a “Color Coding” option, a user may highlight, for example, graphical representations of rail cars or transportation vehicles on any view by the following designations: “Equipment Group”, “Car Kind”, “Product”, “Hazardous”, or “Status”. As a result, a user may find particular groups of cars quickly by selecting a designation from a “Color Coding” drop-down menu, causing the corresponding cars to appear highlighted in the view. The color-coded assets may be shown in the areas within the dashed white ovals in FIG. 7. Similarly, FIG. 8 illustrates an exemplary embodiment of a portion 420 of the string 410 of the displayed view 400 of FIG. 4, showing the color coding of the assets and products of the portion 420. FIG. 9 illustrates an embodiment of a displayed view 900 showing the color coding of graphical representations of assets and products in the list view 500 of FIG. 5. FIGS. 3 and 7-9 herein illustrate the color coding in terms of shades of gray. However, in accordance with an embodiment, the color coding may be accomplished with other non-gray scale colors, providing better discernment to the user. Other types of asset and product coding may be possible as well such as, for example, shape coding of asset and product icons, intensity coding of asset and product icons, and flashing coding (e.g., a displayed icon is first displayed and then not displayed in a regular repeating pattern) of asset and product icons.

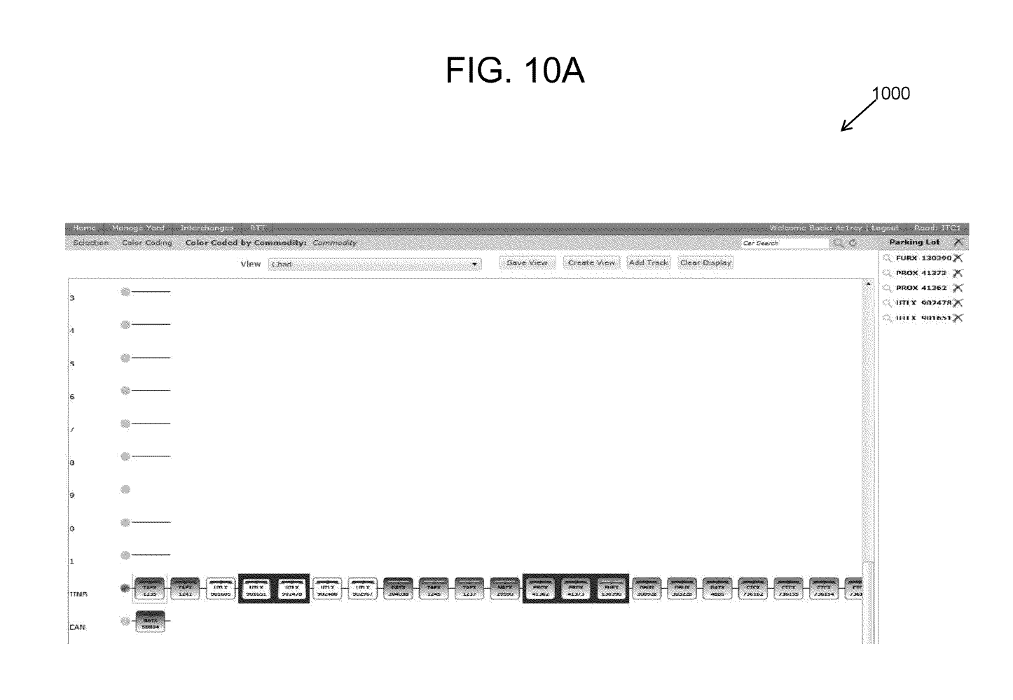

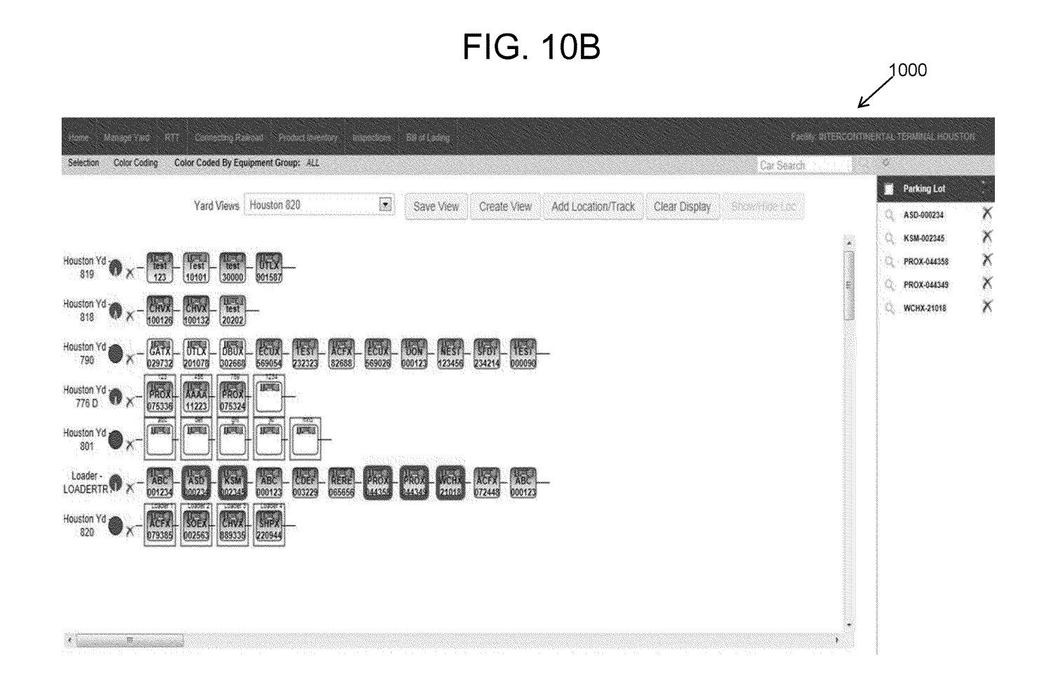

In accordance with an embodiment, the system may be configured for a user to select shipping vehicles in any view based on a variety of criteria including vehicle ID, location, equipment group, or product, allowing a user to choose groups of vehicles quickly and take action based on the criteria. A “parking lot” area or holding area may be provided in each view. For example, FIG. 10 shows an embodiment of display screen of the system 100, which includes a parking lot function. The parking lot function allows a user to temporarily place a group of graphical representations of vehicles and/or containers, with which the user wants to work, into a designated portion of the display (the “parking lot” area) where they may wait until the user is ready to act upon them. To place a graphical representation of a vehicle, or multiple vehicles (e.g., a string), in the parking lot area, a user may select the vehicle(s) and drag and drop the vehicle(s) to the parking lot area in the window. Moving a vehicle to the parking lot area does not make any changes to the vehicle in the system. However, once a group of vehicles are placed in the parking lot area, a user may readily select the entire group and edit the corresponding bill of lading information, or move the group of vehicles together within the representation of the S/R facility within the system 100. The user may then work with several vehicles that may be currently on different tracks or paths, or when the user wants to add multiple vehicles to a consist, for example.

In accordance with an embodiment, the system may be configured for a user to select a “Display Mode” check box to make the parking lot area disappear from the displayed window in the map view. This provides the user with more room to work in the view. Furthermore, when in the “Display Mode”, the system may updates automatically or be manually refreshed to provide the up-to-date information to the user. The user may draw and edit tracks and storage areas such that the map view will match the setup of the plant operation.

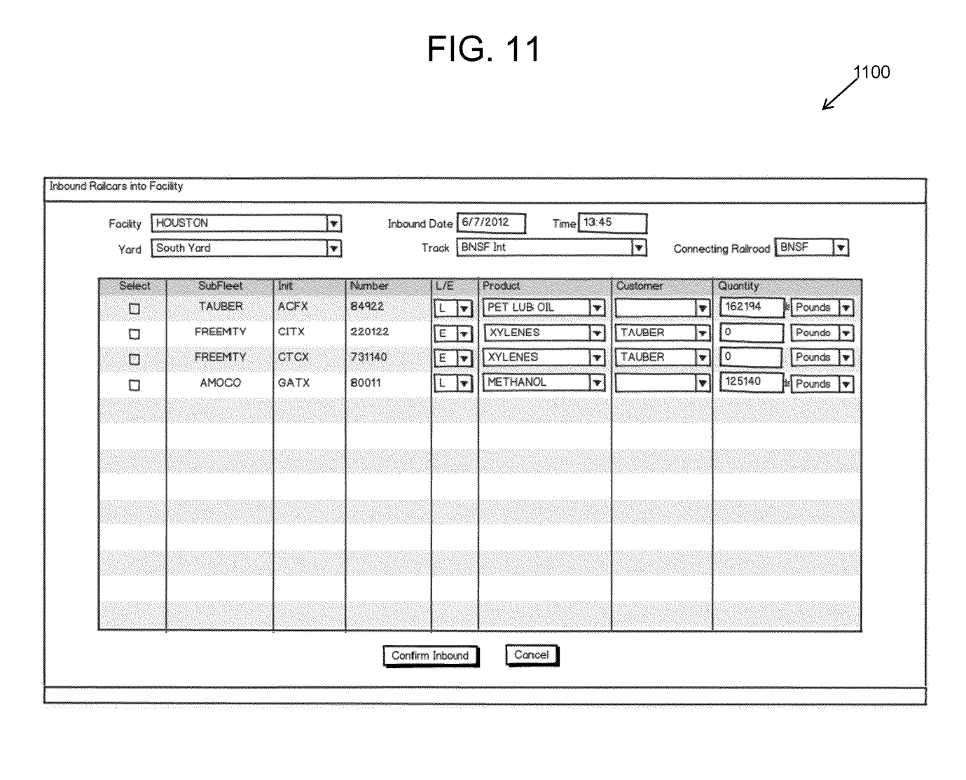

FIG. 11 illustrates an exemplary embodiment of a display screen 1100 generated by the system of FIG. 1 showing information associated with providing interchange support of assets (e.g., inbound rail cars) into the S/R facility. For example, the displayed information may include header information of facility, yard, date and time, track (or road or other asset route), connecting railroad or other connecting shipper, and so on, plus a selectable list of incoming assets (e.g., rail cars) that includes displayed information of subfleet, asset identifier (“Number”), information of what the assets are carrying, and quantities of what the assets are carrying. As part of the user interface, the display screen may include options for a user to modify the information of the incoming assets, confirm the incoming assets, or cancellation of any modifying actions.

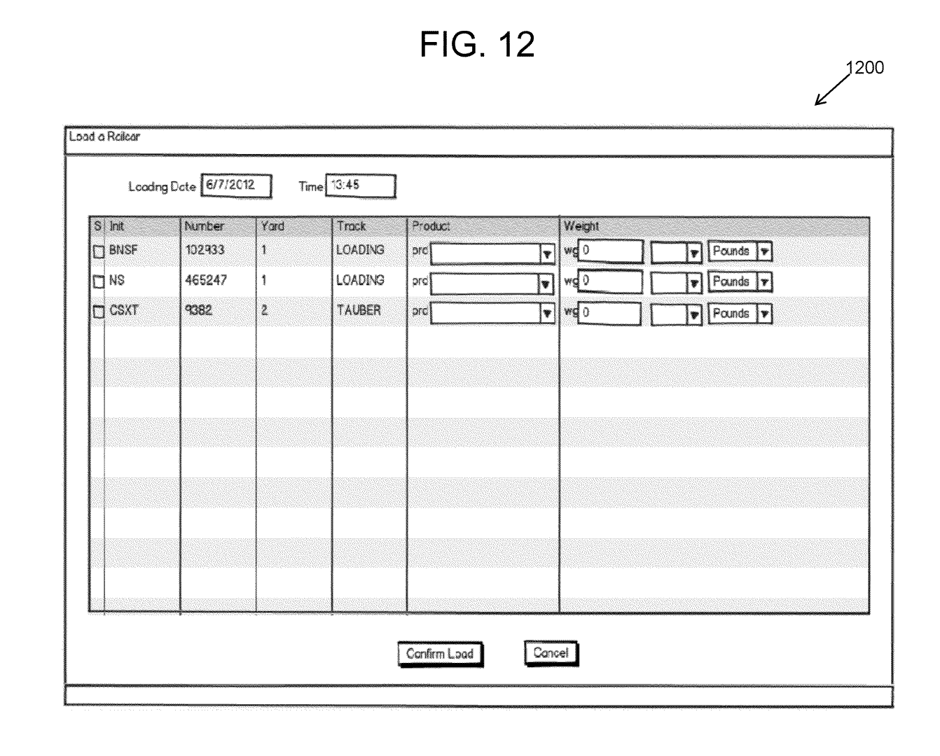

FIG. 12 illustrates an exemplary embodiment of a display screen 1200 generated by the system of FIG. 1 showing information associated with loading an asset (e.g., a railcar) within the S/R facility. For example, the display screen may include a loading date and time in the header, and a list of assets that are to be loaded, or that are being loaded, at or around that time/date. Displayed information of the assets may include asset number or other asset identifier, owner or shipper information, track or other route information of where the asset is currently, or where the asset is to be loaded, and modifiable information of products (e.g., type of product and weight or mass of product) being loaded (or to be loaded) onto the assets.

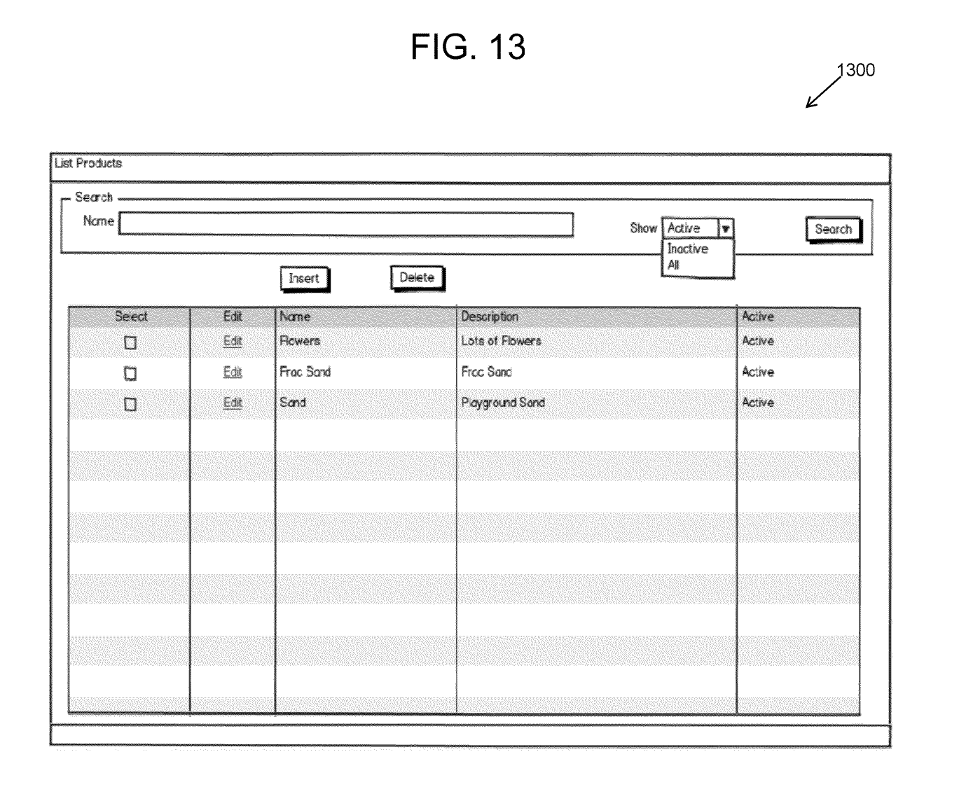

FIG. 13 illustrates an exemplary embodiment of a display screen 1300 generated by the system of FIG. 1 showing information associated with a product master list. For example, the product master list may be a displayed list of product information stored in a database (and associable with assets in others of the displayed screens—see FIGS. 11 and 12 for example), which can be modified via insertion of new products, deletion of existing products, and selection and modification of individual ones of the products, in terms of information about the product such as product name, product description, and whether the product is designated as inactive or active in the system (active meaning currently associable with assets, and inactive meaning not currently associable with assets).

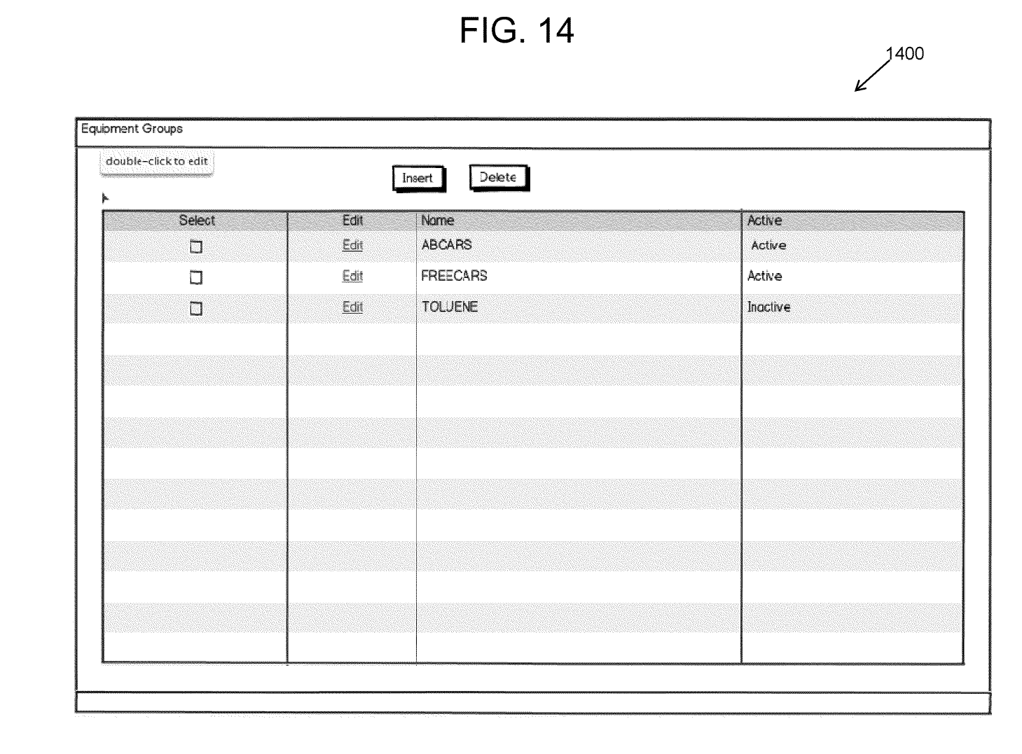

FIG. 14 illustrates an exemplary embodiment of a display screen 1400 generated by the system of FIG. 1 showing information associated with an equipment group master list. For example, the equipment group master list may be a displayed list of equipment group information stored in a database (and associable with assets in others of the displayed screens), which can be modified via insertion of new equipment groups, deletion of existing equipment groups, and selection and modification of individual ones of the equipment groups, in terms of information about the equipment groups such as equipment group name and whether the equipment group is designated as inactive or active in the system.

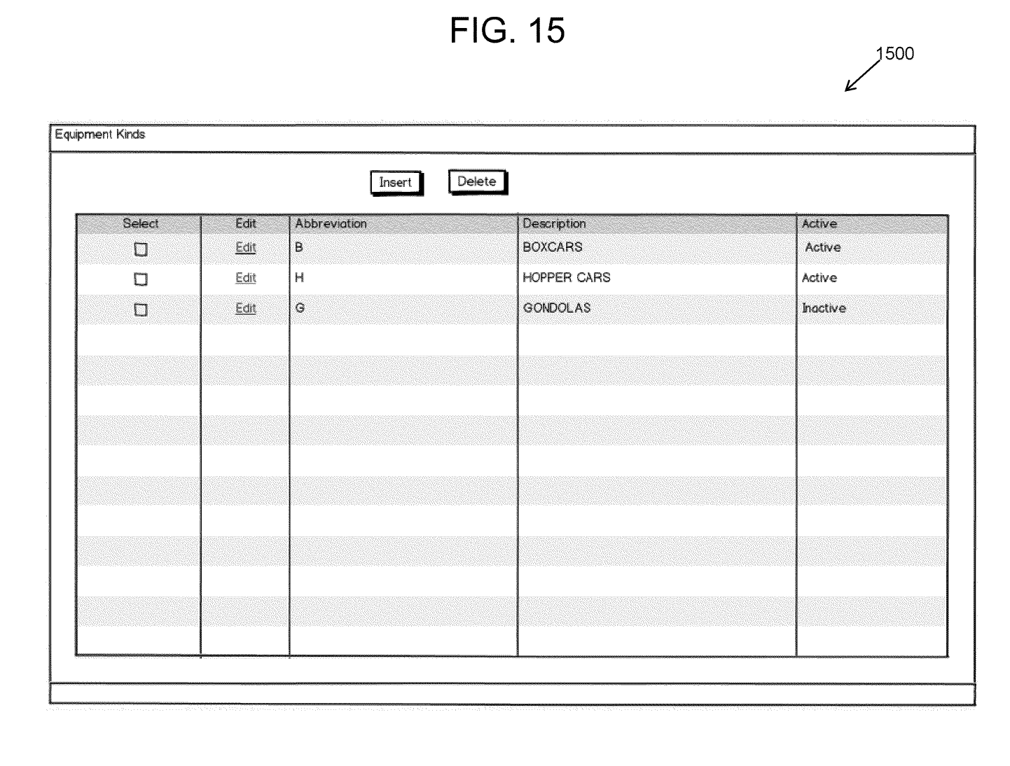

FIG. 15 illustrates an exemplary embodiment of a display screen 1500 generated by the system of FIG. 1 showing information associated with an equipment kind master list. For example, the equipment kind master list may be a displayed list of equipment kind information stored in a database (and associable with assets and/or equipment groups in others of the displayed screens), which can be modified via insertion of new equipment kinds, deletion of existing equipment kinds, and selection and modification of individual ones of the equipment kinds, in terms of information about the equipment kinds such as equipment kind abbreviation, equipment kind description, and whether the equipment kind is designated as inactive or active in the system.

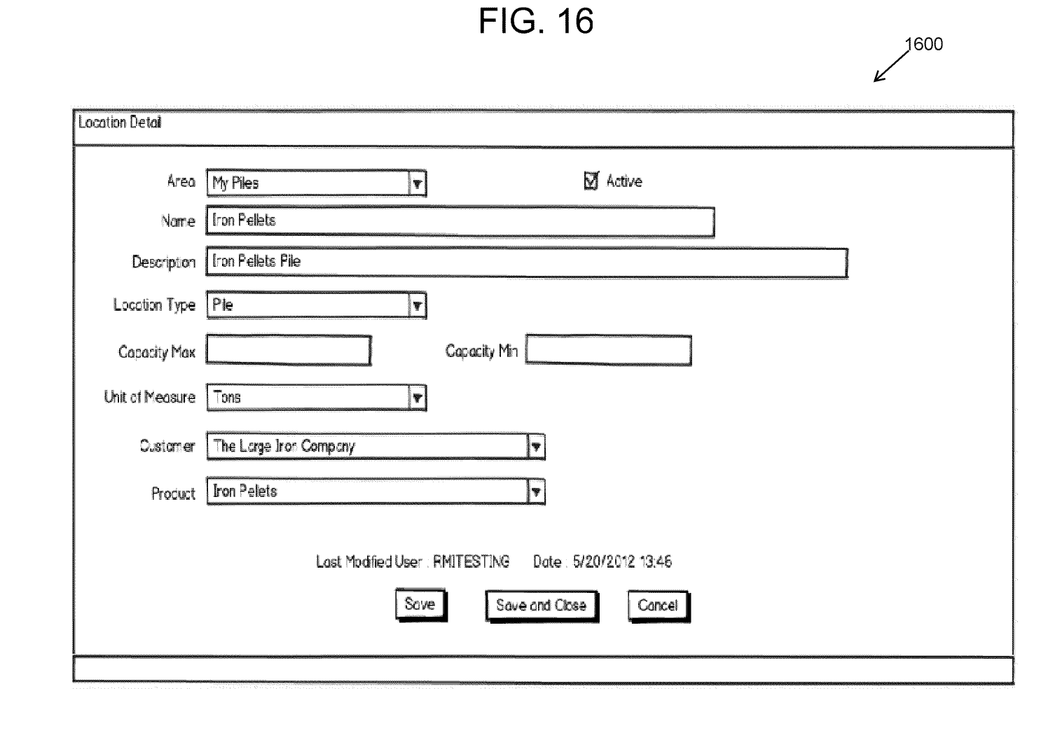

FIG. 16 illustrates an exemplary embodiment of a display screen 1600 generated by the system of FIG. 1 showing information associated with a location (e.g., storage area) master list. For example, the location master list may include, as part of the displayed user interface, user-editable fields for access and modification of associated data records stored in the system. The fields (and associated data record entries) may include location area, location name, location description, location type, location capacity (minimum and/or maximum capacity of what is stored at the location), designated unit of measure of the capacity, customer, and product.

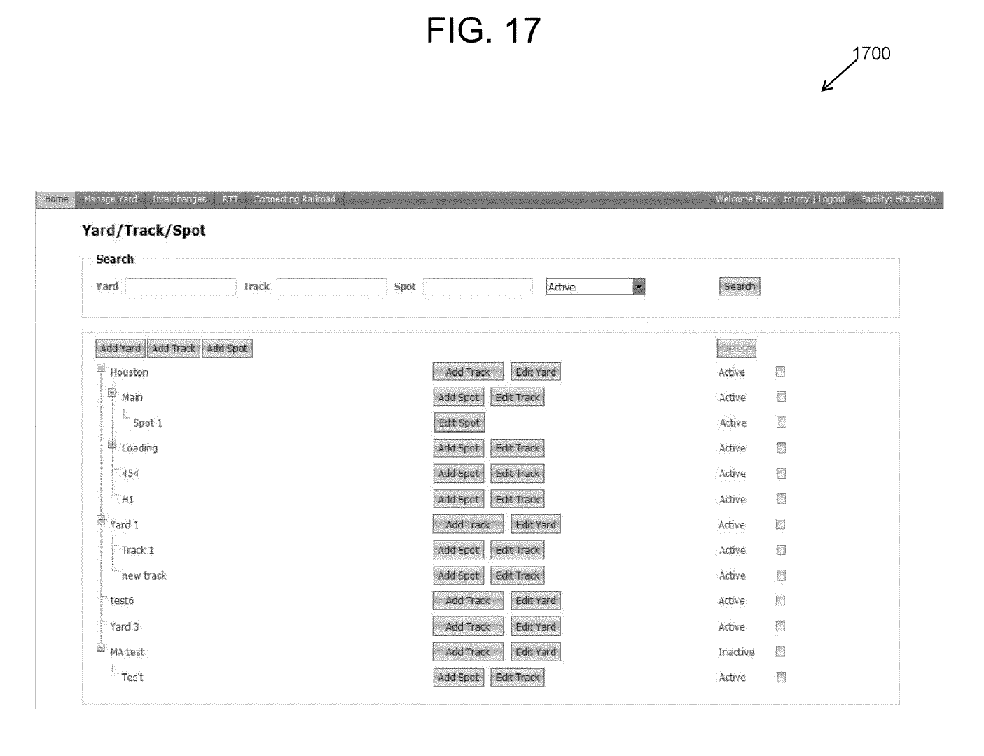

FIG. 17 illustrates an exemplary embodiment of a display screen 1700 generated by the system of FIG. 1 for the setup of infrastructure (e.g., a plant, a track, and/or a spot) within the S/R facility. For example, the display screen may include, as part of the displayed user interface, search fields for user entry of infrastructure information to search for in the system (e.g., search by yard, track, or spot), a display of existing infrastructure (e.g., displayed as a nested hierarchy of infrastructure), user-selectable icons for adding or editing infrastructure elements, and user-selectable icons (e.g., check boxes or radio buttons) for activating and inactivating the infrastructure elements.

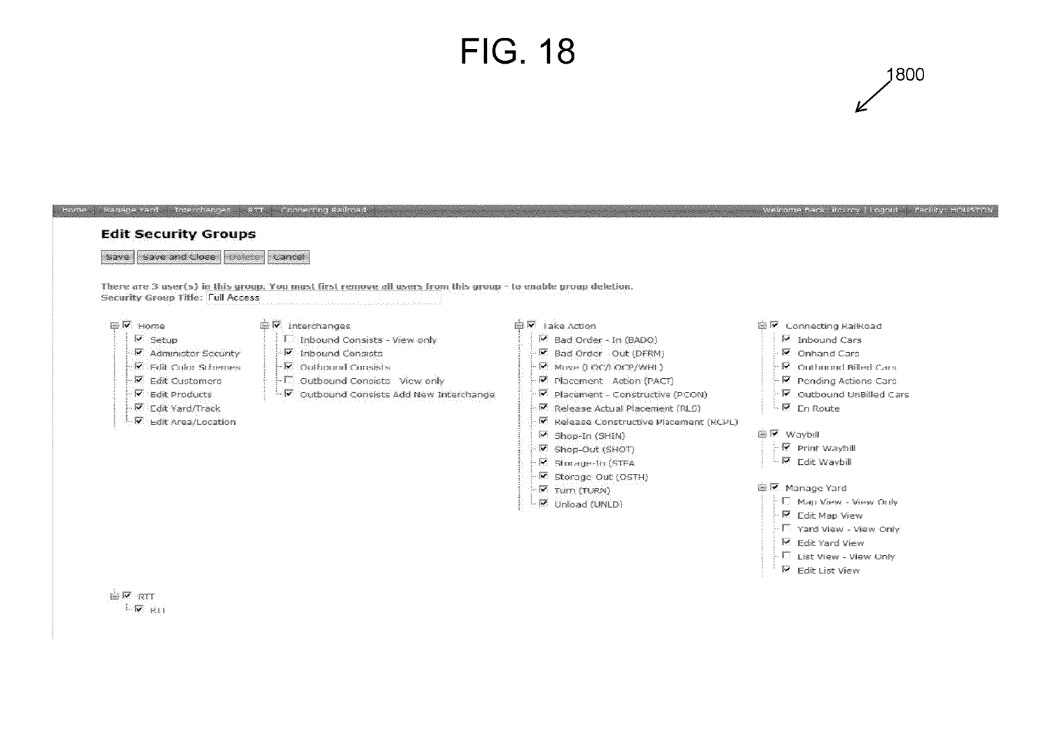

FIG. 18 illustrates an exemplary embodiment of a display screen 1800 generated by the system of FIG. 1 for security and user setup. For example, the display screen may include, as part of the displayed user interface, user-selectable options for allowing respective users in one or more designated groups of users to access (or not access) the various functions of the system.

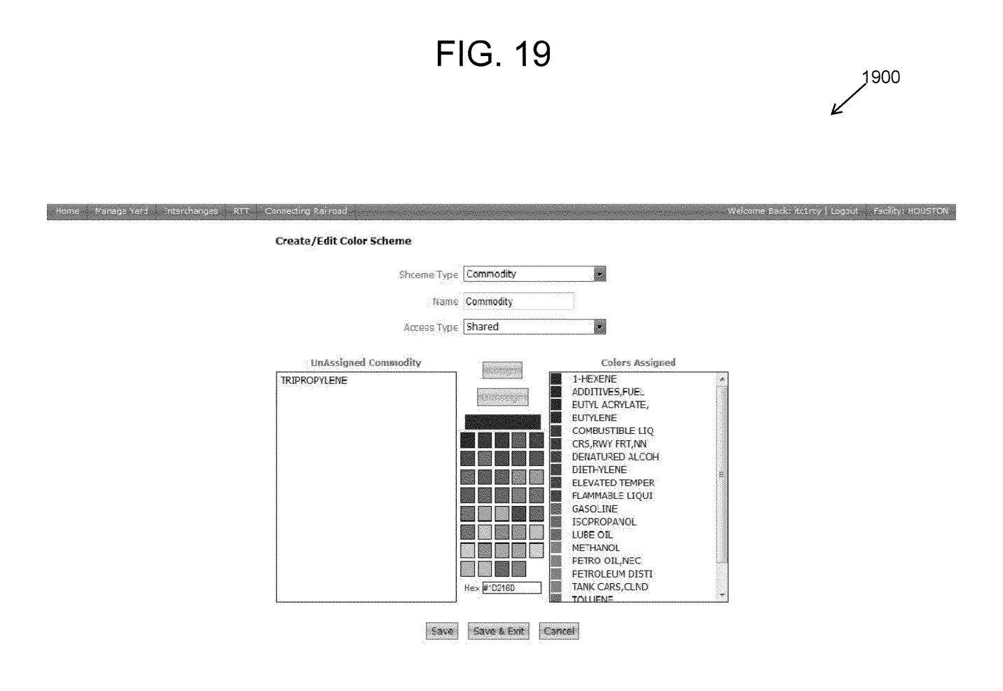

FIG. 19 illustrates an exemplary embodiment of a display screen 1900 generated by the system of FIG. 1 for a color scheme setup of the system. For example, the display screen may include, as part of the displayed user interface, one or more user selectable and/or editable fields for selecting a color scheme type (e.g., each color scheme type may be associated with a particular group of assets, type of product carried on assets, or the like, and for assigning various colors to members of the color scheme type. For example, for each product in the system, the system may be configured for a user to assign a color that is uniquely associated with that product in the system.

In accordance with an embodiment, the controller and the user device may be operable to facilitate the modification of a graphical representation of the S/R facility displayed on a display screen of the user device, facilitate the modification of characteristics of graphical representations of products and assets located within the S/R facility which may be displayed on the display screen of the user device, and facilitate the movement of graphical representations of products and assets within the S/R facility on the display screen of the user device as commanded by the user, including the loading and unloading of products onto and off of assets. The graphical representations and movements may correspond to actual facilities, products, assets, and the actual characteristics and movements of those products and assets in the real world. The modification of a graphical representation of the S/R facility may include adding or deleting graphical representations of tracks or storage areas within the facility. The modification of graphical representations of products and assets may include color coding the graphical representations of the products and assets. The modification of graphical representations or products and assets may include assigning characteristics to the products and assets.

Although trains of rail cars are referred to herein in reference to certain embodiments, certain other embodiments may apply to vehicle consists more generally. A vehicle consist is a group of vehicles that are mechanically linked together to travel along a route. (A rail vehicle consist is one example of a vehicle consist, and a train (e.g., having one or more locomotives for propulsion and one or more rail cars for carrying products and/or passengers and not configured for propulsion) is one example of a rail vehicle consist. Another example of a rail vehicle consist is a set of mining ore carts.) A powered vehicle consist refers to the interaction of two or more powered vehicles that may be mechanically, informationally, or otherwise linked together, as may be the case for a locomotive consist (having multiple locomotives to move a train including the locomotives and one or more unpowered rail cars or other unpowered vehicles).

In one embodiment, the system may record asset and product movement events within the S/R facility. When an actual asset or product moves in an actual S/R facility, a user of the system may update the system to reflect the move. This may be done, for example, by “dragging and dropping” the icon corresponding to the asset or product in a view displayed on the user device. Assets and products may come into the S/R facility through an inbound interchange process. In embodiments, the system is configured so that a user cannot move, place, release, load, or unload assets or products in the system until they are interchanged to the S/R facility. Assets and products stay within the S/R facility until a user moves them to a serving carrier through an outbound interchange.

Using the system, simple track-to-track moves may be made within facility limits. Also, “Classifying” a track provides a way to rapidly move cars and create history records in a large facility, for example. Furthermore, “Fanning” a track allows a user to move cars from one track to multiple other tracks within a facility. Also, “Resequencing” allows a user to change the order of cars on a track. In accordance with an embodiment, the “Classifying”, “Fanning”, and “Resequencing” functions are implemented as scripts or macros in the system. Other scripts or macros can be used to automate or aggregate a series of steps that are repeated and therefore to collapse longer routines into a single action (or the equivalent).

In the system, several move types related to storage are defined that allow a user to move an asset or product into and out of storage, may be recorded to movement history, and may be used to generate storage billing. Several move types may be provided for recording when an asset or product may be defective and in need of repair or replenishing. For example, vehicles and/or containers may be marked as “bad order” in the system and may be flagged on various windows and reports throughout the system. When the car is repaired, the car may be moved in the system off the “bad order” list. Each time a car is moved by a user in the system, a record of the move may be written to a car movement history file which may be accessed.

The controller and associated management software application 115 may include logic that provides an assessment, in comparison to one or more designated criteria, of the movement of assets and products in the system as initiated by a user. For example, there may be some asset movements that may be impossible, highly improbable, or unlikely to take place in a facility. If a user attempts to make such a movement of an asset in the system, the system may disallow the move or at least provide an indication to the user that the move may be highly unusual and suggest that the user may want to reconsider the move. Furthermore, movement of assets and products within the system made by a user may be verified, for example, against data collected within the actual facility corresponding to the actual movement of the assets or products (e.g., radio-frequency identification (RFID) data or optical character recognition (OCR) data). The actual movement of assets and products in the facility may also be time stamped, allowing the system to perform efficiency analysis of the movement of assets and products through the S/R facility.

In accordance with an embodiment, the system allows a user to review and edit shipping and receiving information for any asset and associated product. For example, basic shipping/receiving information (e.g., Bill of Lading or waybill information) for a car or other asset may appear on the screen when a user, for example, hovers a cursor over that car on the display screen. The S/R information may be edited by right-clicking on the car and selecting “Edit S/R Information”, for example. Data may then be edited and/or added via a pop-up window. In accordance with an embodiment, data fields include “Customer”, “Equipment Group”, “Product”, “Quantity” and “Seals”. Other S/R data fields (e.g., load railcars, unload railcars, associate with an order, outbound railcars, and inspections) may be possible as well, in accordance with various embodiments of the invention.

In accordance with an embodiment, the system allows a user to periodically review consists delivered to the S/R facility. When the user sees a new inbound consist listed, the user may check the cars on that consist and plan for interchanging and switching cars as they may be received. Cars of an inbound consist may be officially accepted by the user and moved into inventory in the S/R facility. Cars cannot be moved in the system until the user interchanges them online, however. After cars may be accepted from a consist, the cars may be managed automatically or manually via the system. When a user is ready to deliver cars from the S/R facility, a user may transmit the outbound consists in advance of actual delivery, or transmit the outbound consists at the time of delivery. Once an outbound interchange is delivered, the cars may be tracked and managed along the route to the destination facility.

In one embodiment, the user device has functionality to determine its own location, the current time, and to identify a nearby asset or product via, for example, near field RFID, barcode scanning, manual entry, OCR, or the like. This allows a user to update the system with an asset or product location at a particular time. The system may then compare the gathered information against an assumed location of the asset or product. Alternatively, using the location of the user device and the assumed location of the asset or product, the system may guide a user to the asset or product.

The system may indicate certain paths, track sections, or storage areas that may be occupied, or will be occupied, or may be closed (e.g., for repair). The system may then calculate an optimal path from the current location to a user indicated new location. That path may be checked against the path or track sections that may be unavailable, or may be unavailable during the time such a move of the asset or product may be intended. In one aspect, the path of travel may be indicated on the user device, and the path may be re-drawn by user input and/or by other rules or constraints applied by the user.

In one embodiment, a future arrival of a vehicle or container may be indicated as well as an estimated time of arrival of that vehicle or container. Thus, the S/R facility may indicate an inbound train, calculate a breakdown of the incoming containers, and check for existing obstructions on the intended path of the incoming containers so that such obstructions (such as other parked assets) may be moved prior to the arrival of the vehicle or container.

In an example of a system including at least one embodiment of an inventory workload management (IWM) module, products and/or materials may be tracked by amount and location (e.g., within a facility) using a controller. Assets and their associated locations may additionally be tracked, and orders may be tracked along with statuses associated with such orders. At least these aspects may be mapped. Mapping may include, but may be not limited to, display of a map (e.g., representation of space including aspects facilitating orientation and association with physical locations) and the addition, superimposition, blending, replacement, et cetera of visual aspects to represent products/materials, assets, and orders according to at least their location and/or status.

In embodiments, a controller may be used to assign or otherwise associate products, assets, and orders in combinations facilitating inventory and workload management. Asset classes may be selected and associated with at least products in addition to the assignment of individual assets.

Various aspects of the map may be updated in response to actions at the controller or elsewhere. In embodiments, one or more display screens (e.g., of the controller, of a mobile device, of a computer, of a machine, and others) may display the map.

Production planning may be facilitated according to embodiments of an IWM module. For example, products being tracked may be determined to be required in certain amounts to keep pace with orders, current and/or anticipated demand, asset capacity and availability, and/or production capacity or over a given period of time. In embodiments, a projected amount of products may be used in determining a production schedule for the product. Projected amounts may be based at least in part on, for example, orders and/or order statuses. In alternative or complementary embodiments, a production schedule may be determined based at least in part on assets and/or asset locations. In another alternative or complementary embodiment, a production schedule may be based on a product consumer schedule (e.g., the schedule of a consumer ordering the product).

Various systems may be used to implement aspects related to IWM modules. In one or more embodiments, an inventory monitor module may be used in systems (e.g., software applications or a facility controller running the software application) to track a product inventory of one or more products (e.g., at a facility).

In embodiments, an asset monitor module may track an asset inventory of one or more assets (e.g., at the facility). In addition, an order status module may maintain an order record including the orders and associated statuses (e.g., most recent, statuses over time, other information). At least these modules may provide information to a graphical interface module that may virtually represent at least a portion of this information (e.g., on a map). The graphical interface module may represent different amounts of product (and/or assets or other aspects).

Embodiments of systems as described herein may include a production output module to determine amounts of products being added to an inventory (e.g., as a result of production). Embodiments may additionally include an asset capacity module that may determine total capacities, used capacities, unused capacities, and/or alternative utilizations of capacities of one or more assets. In another alternative or complementary embodiment, a combination module may combine information (e.g., weight, volume, value, ratio, blending, specification, testing, certification, and others) related to two or more products that may be stored together in a combination asset (e.g., asset designated to include two or more products simultaneously, asset designated for mixing or blending products, and so forth).

Embodiments of systems herein may include various distinct and/or distributed sub-systems, such as enterprise resource systems, controllers (e.g., facility management controller), and/or user devices (e.g., proprietary, commercial/consumer with modified functionality or app installed, and so forth). For example, an enterprise resource system may schedule one or more transfers of inventory (e.g., from a facility). The controller may communicate with at least the enterprise resource system and may direct production and/or control of products/material at the facility. The controller may direct production and/or control based on, for example, the inventory, the transfer of inventory, and locations (e.g., map data) related thereto. The user device may be in communication with at least the controller and receive information there from including at least a resource map that shows location information related to the inventory and the transfer(s). This information may be displayed at the user device (e.g., on a visual display).

In embodiments, maps or other location-based aspects herein may depict a plurality of geographically disparate locations, facilities, entities, et cetera. For purposes of aspects herein, “geographically disparate” may mean around the world, but refers to locations not immediate to or within a facility. Transfers may be shown between geographically disparate facilities on or related to a true map (e.g., of the United States) or a symbolic map (e.g., line drawn between representations of both facilities showing transfer between two facilities, line drawn between representations of both facilities that may be graduated according to time or distance, and so forth).

In embodiments, various aspects may be determined by the enterprise resource system(s), controller(s), user device(s), and/or other modules or sub-module interacting therewith. For example, a time of completion (e.g., when one or more portions of a transfer will reach the destination and be accepted by a recipient) may be calculated for a transfer. Subsequent transfers may be scheduled based on the time of completion or other aspects, permitting a continuous flow of transfers as benefits just-in-time (JIT) or other efficiency-focused production techniques. In complementary or alternative embodiments, the facility management controller (or other modules) may select an asset to retain at least a portion of the inventory (e.g., at the facility).

In embodiments, an IWM module may utilize statistics to forecast and improve aspects related to inventory management or workload management. In an embodiment, statistical information may facilitate the development of high resolution management metrics and estimates that may distinguish between workers, lines, areas, types of products or assets, et cetera, to ensure accurate and reliable inventory and workload management. For example, a new order may require modification to a production schedule. This order may be assigned to a particular line on a particular shift, which produces at a different rate than other lines and shifts. In addition, the order may be planned for delivery using a particular asset that may be more or less difficult to load and stage than other assets. Rather than relying on facility-wide or enterprise-wide estimates, an IWM module may use various order information to provide detailed performance information that may be used in at least complex estimates directed toward efficient management.

In another embodiment, a method (e.g., for inventory and workflow management) may include various aspects using a controller, such as receiving one or more product locations of one or more products within a facility, receiving one or more asset locations of one or more assets within the facility, receiving an order for at least one of the one or more products, assigning at least a portion of the at least one of the one or more products to at least one of the one or more assets to complete the order, and scheduling a fulfillment of the order based one or more workflow times associated with one or more tasks. The one or more tasks may include one or more of receiving, inspecting, cleaning, repairing, maintaining, moving, loading, unloading, transferring, and testing of the one or more products or the one or more assets. A map of the facility may be generated that includes representations of the one or more products at the one or more product locations (the one or more assets at the one or more asset locations, and one or more locations associated with the order), and/or visually representing the map with respective visual characteristics on a display screen of a user device in operative communication with the controller. An order status update may be received that is based at least in part on the tasks. The map may be updated based on the order status update. A production schedule may be determined for the one or more products based on at least the fulfillment and the order, and/or releasing the at least one of the one or more assets for transport based on the fulfillment. One or more production schedules may be further based on a customer schedule. An order status update based on the one or more tasks may be received, and an alert may be given in response to the order status update.

In an embodiment, a controller may be configured to receive a product inventory relating to one or more products at a facility, receive an asset inventory relating to one or more assets at the facility, receive a set of orders including one or more product orders, and one or more statuses associated respectively with the one or more product orders (wherein the statuses include location information describing at least one location associated with the one or more products and the one or more assets). The controller may be configured to control generation of a representation of at least a map of the facility including the location information to be displayed on a user device, and may produce a notification based on the location information that prompts one or more tasks related to the set of orders. In one embodiment, the controller may modify the product inventory based on the set of orders, and schedule an inventory replenishment based on the set of orders. In alternative or complementary embodiments, the controller may calculate a total storage capacity of at least a subset of the asset inventory, and may calculate an available capacity of at least the subset of the asset inventory, wherein the inventory replenishment may be further based on at least one of the total capacity and the available capacity. In addition, the controller may calculate a fulfillment rate based on at least the set of orders, and/or to schedule a downtime associated with at least a portion of the facility based on the set of orders.

The system may include an enterprise resource planning system, a controller, and a user device. The enterprise resource planning system may schedule an order to be fulfilled from an inventory at a facility. The controller may be associated with the facility and may be communicatively linked to the enterprise resource planning system, and may allocate the inventory to a plurality of assets at the facility based at least in part on the order. The user device may be communicatively linked to the controller, and may receive from the facility management controller a workflow list based on the order. In addition, the workflow list may include at least one task that completes the order by causing a portion of the inventory for the order to ship to a customer, and/or at least one task that replenishes the inventory based on at least the order. The user device may transmit an update to the workflow list based on activity that modifies at least one of an order status or an inventory status, and/or the enterprise resource planning system may schedule a subsequent order based on a fulfillment time associated with the order. In addition, the controller may schedule repositioning of at least a portion of the inventory or at least one of the plurality of assets based on the order.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it may be related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., may distinguish one element from another.

This written description uses examples to disclose the invention, including the best mode, and also to enable one of ordinary skill in the art to practice the invention, including making and using any devices or systems and performing any incorporated methods. The embodiments described herein may be examples of articles, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A method, comprising:
receiving one or more product locations of one or more products within a facility;
receiving one or more asset locations of one or more assets within the facility;
receiving an order for at least one of the one or more products;
assigning at least a portion of the at least one of the one or more products to at least one of the one or more assets to complete the order; and
scheduling a fulfillment of the order based on one or more workflow times associated with one or more tasks.

2. The method of claim 1, wherein the one or more tasks include one or more of receiving, inspecting, cleaning, repairing, maintaining, moving, loading, unloading, transferring, or testing of the one or more products or the one or more assets.

3. The method of claim 1, further comprising generating a map of the facility including representations of the one or more products at the one or more product locations, the one or more assets at the one or more asset locations, and one or more locations associated with the order.

4. The method of claim 3, wherein the map is generated with visual characteristics, representing at least the one or more product locations and the one or more asset locations, on a display screen of a user device.

5. The method of claim 3, further comprising:
receiving an order status update based on the one or more tasks; and
updating the map based on the order status update.

6. The method of claim 1, further comprising determining a production schedule within the facility for the one or more products based on at least the fulfillment and the order.

7. The method of claim 6, wherein the production schedule is further based on a customer schedule.

8. The method of claim 1, further comprising:
receiving an order status update based on the one or more tasks; and
generating an alert based on the order status update.

9. The method of claim 1, further comprising releasing the at least one of the one or more assets for transport based on the fulfillment.

10. A system comprising a controller configured to:
receive a product inventory relating to one or more products at a facility;
receive an asset inventory relating to one or more assets at the facility;
receive a set of orders including one or more product orders and one or more statuses associated respectively with the one or more product orders, wherein the statuses include location information describing at least one location associated with the one or more products and the one or more assets;
control generation of a graphical representation of the facility including the location information to be displayed on a user device; and
produce a notification based on the location information that prompts one or more tasks related to the set of orders.

11. The system of claim 10, wherein the controller further is configured to:
modify the product inventory based on the set of orders; and
schedule an inventory replenishment based on the set of orders.

12. The system of claim 11, wherein the controller is further configured to:
calculate a total storage capacity of at least a subset of the asset inventory; and
calculate an available capacity of at least the subset of the asset inventory, wherein the inventory replenishment is further based on at least one of the total capacity or the available capacity.

13. The system of claim 10, wherein the controller is further configured to calculate a fulfillment rate based on at least the set of orders.

14. The system of claim 10, wherein the controller further is configured to schedule a downtime associated with at least a portion of the facility based on the set of orders.

15. A system, comprising:
an enterprise resource planning system configured to schedule an order to be fulfilled from an inventory at a facility;
a controller associated with the facility and communicatively linked to the enterprise resource planning system, wherein the controller is configured to allocate the inventory to a plurality of assets at the facility based at least in part on the order; and
a user device communicatively linked to the controller and configured to receive from the controller a workflow list based on the order.

16. The system of claim 15, wherein the workflow list includes at least one task that completes the order by causing a portion of the inventory for the order to ship to a customer.

17. The system of claim 16, wherein the workflow list includes at least one task that replenishes the inventory based on at least the order.

18. The system of claim 15, wherein the user device is further configured to transmit an update to the workflow list based on activity that modifies at least one of an order status or an inventory status.

19. The system of claim 15, wherein the enterprise resource planning system is further configured to schedule a subsequent order based on a fulfillment time associated with the order.

20. The system of claim 15, wherein the controller is further configured to schedule repositioning of at least a portion of the inventory or at least one of the plurality of assets based on the order.
